(19) United States
(12) Patent Application Publication
(10) Pub. No.: US 2023/0422172 A1
(43) Pub. Date: Dec. 28, 2023

(54) LOW POWER WAKE-UP SIGNAL WITH TWO PARTS IN TIME DOMAIN

(71) Applicant: Intel Corporation, Santa Clara, CA (US)

(72) Inventors: Yingyang Li, Beijing (CN); Yi Wang, Beijing (CN); Gang Xiong, Portland, OR (US); Debdeep Chatterjee, San Jose, CA (US); Toufiqul Islam, Milpitas, CA (US)

(21) Appl. No.: 18/465,698

(22) Filed: Sep. 12, 2023

Related U.S. Application Data
(60) Provisional application No. 63/411,545, filed on Sep. 29, 2022.
(60) Provisional application No. 63/484,959, filed on Feb. 14, 2023.

(51) Int. Cl. H04W 52/02; H04W 52/52; H04L 27/02

(52) U.S. Cl. CPC H04W 52/0235; H04W 52/52; H04L 27/02

(57) ABSTRACT

Various embodiments herein provide techniques for a low power wake-up signal (LP-WUS) with two parts. The LP-WUS may be received by a wake-up receiver of a user equipment (UE) and used to trigger a main receiver of the UE to wake up (e.g., turn on or enter a higher power state). The first part may be used to indicate the presence and/or other characteristics of the second part. The first and second parts may each be transmitted in one or more symbols, slots, or time resource units. Other embodiments may be described and claimed.

### CROSS REFERENCE TO RELATED APPLICATION

The present application claims priority to U.S. Provisional Patent Application No. 63/411,545, which was filed Sep. 29, 2022; and to U.S. Provisional Patent Application No. 63/484,959, which was filed Feb. 14, 2023; the disclosures of which are hereby incorporated by reference.

### FIELD

Various embodiments generally may relate to the field of wireless communications. For example, some embodiments may relate to a low power wake-up signal with two parts in the time domain.

### BACKGROUND

Fifth generation (5G) cellular communication systems are designed and developed targeting both mobile telephony and vertical use cases. Besides latency, reliability, availability, and user equipment (UE) energy efficiency are also important to 5G. Currently, 5G devices may have to be recharged once per week or day, depending on individual's usage time. In general, 5G devices consume tens of milliwatts in radio resource control (RRC) idle/inactive state and hundreds of milliwatts in RRC connected state. Techniques to prolong battery life are a necessity for improving energy efficiency as well as for better user experience.

The power consumption of a UE depends on the configured length of wake-up periods, e.g., paging cycle. To meet the battery life requirements, long discontinuous reception (DRX) cycle is expected to be used, resulting in high latency, which is not suitable for such services with requirements of both long battery life and low latency. For example, in fire detection and extinguishment use case, in which fire shutters are to be closed and fire sprinklers turned on by the actuators within 1 to 2 seconds from the time the fire is detected by sensors, long DRX cycle cannot meet the delay requirements. Therefore, it is necessary to reduce the power consumption with a reasonable latency. Currently, UEs need to periodically wake up once per DRX cycle, which dominates the power consumption in periods with no signaling or data traffic.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1A schematically illustrates a main receiver and a wake-up receiver of a user equipment (UE) when a wake-up signal is off, in accordance with various embodiments.

FIG. 1B schematically illustrates the main receiver and the wake-up receiver when the wake-up signal is on, in accordance with various embodiments.

FIG. 2 illustrates a wake-up signal/channel with two parts, in accordance with various embodiments.

FIG. 3 illustrates an example of subframe timing determination, in accordance with various embodiments.

FIGS. 4A, 4B, and 4C illustrate an example patterns for spreading and repetition in accordance with various embodiments.

FIG. 5A illustrates an example of a common part 1 for multiple low-power—wake-up signals (LP-WUSs), in accordance with various embodiments.

FIG. 5B illustrates another example of a common part 1 for multiple LP-WUSs, in accordance with various embodiments.

FIG. 6A illustrates an example of part 1 and part 2 of the LP-WUS transmitted in multiple subframes or slots, in accordance with various embodiments.

FIG. 6B illustrates an example of part 1 transmitted in one subframe or slot and part 2 transmitted in multiple subframes or slots, in accordance with various embodiments.

FIG. 6C illustrates an example of part 1 transmitted in a first subset of one or more subframes or slots and part 2 transmitted in a second subset of one or more subframes or slots, in accordance with various embodiments.

FIG. 6D illustrates an example of part 2 transmitted in remaining resources of a subframe or slot that are not used by part 1, in accordance with various embodiments.

FIG. 7A illustrates an example of part 1 and part 2 transmitted in multiple time resource units (TRUs), in accordance with various embodiments.

FIG. 7B illustrates an example of part 1 transmitted in a first subset of one or more TRUs and part 2 transmitted in a second subset of one or more TRUs, in accordance with various embodiments.

FIG. 7C illustrates an example of part 2 transmitted in remaining resources of a TRU that are not used by part 1, in accordance with various embodiments.

FIG. 8 schematically illustrates a wireless network in accordance with various embodiments.

FIG. 9 schematically illustrates components of a wireless network in accordance with various embodiments.

FIG. 10 is a block diagram illustrating components, according to some example embodiments, able to read instructions from a machine-readable or computer-readable medium (e.g., a non-transitory machine-readable storage medium) and perform any one or more of the methodologies discussed herein.

FIG. 11 illustrates an example procedure to practice various embodiments herein.

FIG. 12 illustrates another example procedure to practice various embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein provide techniques for a low power wake-up signal (LP-WUS) with two parts. The LP-WUS may be received by a wake-up receiver of a user equipment (UE) and used to trigger a main receiver of the UE to wake up (e.g., turn on or enter a higher power state). The first part may be used to indicate the presence and/or other characteristics of the second part. The first and second parts may each be transmitted in one or more symbols, slots, or time resource units.

As discussed above, under current specifications, UEs need to periodically wake up once per DRX cycle, which dominates the power consumption in periods with no signaling or data traffic. If UEs are able to wake up only when they are triggered, e.g., using paging, power consumption could be dramatically reduced. For example, the network (e.g., next generation Node B (gNB)) may send a wake-up signal to trigger the UE to turn on a main receiver of the UE. In embodiments, the UE may include a wake-up receiver in a UE that is separate from the main receiver. The wake-up receiver may have the ability to monitor for the wake-up signal with ultra-low power consumption, and trigger the main receiver to turn on if the wake-up signal is received. The main receiver may be used for data transmission and reception, and can be turned off or set to deep sleep unless it is turned on.

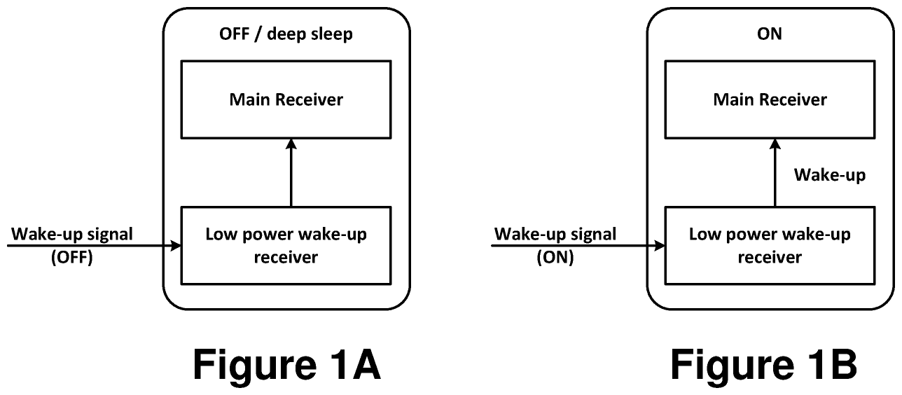

FIGS. 1A and 1B illustrate one example for the use of a main receiver and a wake-up receiver in a UE. In the power saving state as shown in FIG. 1A, if no wake-up signal is received by the wake-up receiver, the main receiver stays in OFF state for deep sleep. On the other hand, if a wake-up signal is received by the wake-up receiver as shown in FIG. 1B, the wake-up receiver will trigger to turn on the main receiver. In the latter case, since main receiver is active, the wake-up receiver can be turned off.

The power consumption for monitoring wake-up signal depends on the wake-up signal design and the hardware module of the wake-up receiver used for signal detecting and processing.

Various embodiments herein provide a low-power wake-up signal (LP-WUS) with a two part structure, e.g., in the time domain. For the extremely low power consumption of the wake-up receiver (WUR), the WUR can only do non-coherent detection for the LP-WUS, e.g., envelope detection. For example, modulation schemes such as ON-OFF Keying (OOK) or frequency shift keying (FSK) may be used for the LP-WUS. In an orthogonal frequency division multiplexing (OFDM) system, the OOK or FSK modulation may be mapped on multiple subcarriers, e.g., multi-carrier OOK (MC-OOK) or MC-FSK. As used herein, a WUS symbol may refer to an OOK symbol, a FSK symbol, a MC-OOK symbol, a MC-FSK symbol, or another suitable symbol.

In some embodiments, the LP-WUS may be mapped to the duration of consecutive OFDM symbols. The start of a LP-WUS may be defined relative to the start of a slot, a subframe, a half radio frame or a radio frame by an offset. The total duration of LP-WUS is dependent on the payload size that is carried by the LP-WUS.

LP-WUS with at Least Two Parts

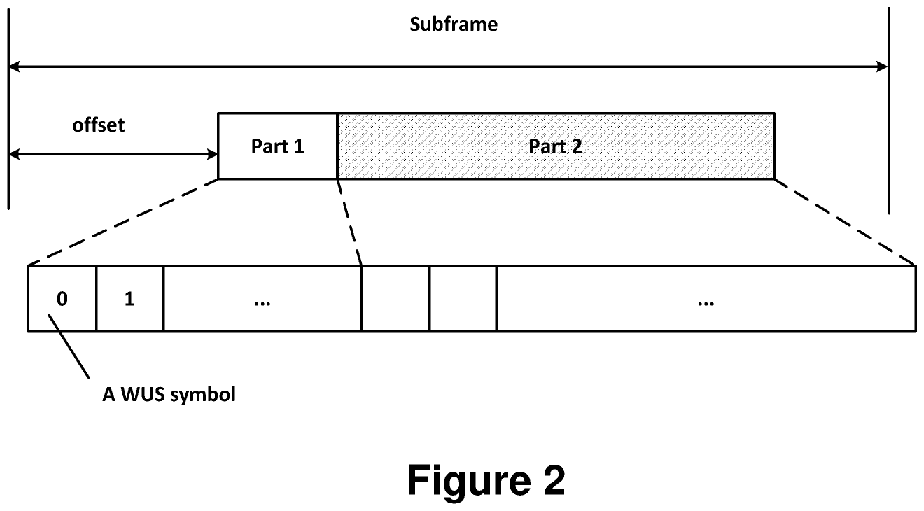

In various embodiments, a LP-WUS may include at least two parts. A first part may be for the WUR receiver to prepare for the detection of the second part which carries the wake-up information. Both parts may consist of multiple WUS symbols. The two parts may be consecutive in time. Alternatively, there can be a time gap between the first part and the second part. The length of the gap may be predefined or configured by high layer signaling. FIG. 2 illustrates one example for two parts of a LP-WUS which is allocated within a subframe.

The first part is typically generated based on a sequence, and the second part which carries the wake-up information, which is typically using channel coding. For example, the sequence for the WUS symbols in the first part may be predefined or configured. The channel coding for the second part may be a spreading operation or repetition coding. Other channel coding scheme(s) for the first part or the second part may be used in accordance with various embodiments. The first part of LP-WUS may be used for AGC and/or time/frequency synchronization. If the first part is detected with an energy or power level higher than a threshold, the UE may further detect the second part. In other words, the first part is an indicator on whether the second part is transmitted or not. Further, the first part may also carry one or more information bits.

In one embodiment, multiple sequence lengths of the first part of a LP-WUS can be supported. In one option, one sequence consists of repetitions of a short sequence. The multiple sequence lengths of LP-WUS may be obtained by different number of repetitions of a short sequence in the first part. In another option, one sequence consists of a long sequence. The multiple sequence lengths of LP-WUS may be supported by different long sequence with different length in the first part.

In one embodiment, multiple durations of a WUS symbol may be supported for the first part of a LP-WUS. The duration of a WUS symbol for the first part of LP-WUS can be predefined, or configured by high layer signaling.

In one option, for the first part with different sequence lengths, the duration of a WUS symbol in the first part can be same or different. For each sequence length of first part, the duration of a WUS symbol for the first part can be predefined, or configured by high layer signaling. The duration of a WUS symbol can be determined by the sequence length of the first part. For example, there can be one-to-one mapping between value the sequence length of the first part and the duration of a WUS symbol. Alternatively, if multiple durations of WUS symbol supported for a sequence length of the first part, the duration of WUS symbol can be configured by high layer from the set of supported durations for the sequence length of the first part.

In one embodiment, multiple durations of a WUS symbol may be supported for the second part of a LP-WUS.

In one option, the duration of a WUS symbol for the second part of LP-WUS can be predefined, or configured by high layer signaling.

In another option, the same duration of a WUS symbol may be applied to both the first part and the second part of a LP-WUS.

In another option, the duration of a WUS symbol for the second part may be different from that of the first part of a LP-WUS. There can be one-to-one mapping between duration of a WUS symbol of the first part and the duration of a WUS symbol of the second part. Alternatively, if multiple duration of WUS symbol of the second part are supported corresponding to a duration of WUS symbol of the first part, the duration of WUS symbol of the second part can be configured by high layer from the set of supported values for the duration of WUS symbol of the first part.

In another option, there can be one-to-one mapping between duration of a WUS symbol of the second part and the sequence length of the first part. Alternatively, if multiple duration of WUS symbol of the second part are supported corresponding to a sequence length of the first part, the duration of WUS symbol of the second part can be configured by high layer from the set of supported values for the sequence length of the first part.

In another option, there can be one-to-one mapping between duration of a WUS symbol of the second part and the duration of the first part. Alternatively, if multiple duration of WUS symbol of the second part are supported corresponding to a duration of the first part, the duration of WUS symbol of the second part can be configured by high layer from the set of supported values for the duration of the first part.

In one embodiment, multiple coding rate may be supported for the second part of a LP-WUS. For simplicity, the coding scheme may be just a spreading operation. In this case, the coding rate is reflected by the spreading factors (SF). Multiple spreading sequences with a spreading factor may be applicable. Note: repetition coding can be considered as a special case for spreading too.

In one option, the coding rate or spreading factor of the second part of LP-WUS can be predefined, or configured by high layer signaling.

In another option, the coding rate or spreading factor of the second part can be determined by the sequence length of the first part. There can be one-to-one mapping between coding rate or spreading factor of the second part and the sequence length of the first part. Alternatively, if multiple coding rates or spreading factors of the second part are supported corresponding to a sequence length of the first part, the coding rate or spreading factor of the second part can be configured by high layer from the set of supported values for the sequence length of the first part.

In one embodiment, multiple lengths of LP-WUS can be supported.

In one option, the length of LP-WUS can be indicated by the first part. Alternatively, the length of LP-WUS can be predefined or configured by high layer signaling. In some embodiments, one of the following mechanisms may be used to indicate the length of LP-WUS:
The duration of LP-WUS
The duration of the second part of LP-WUS
The number of WUS symbols in the LP-WUS
The number of WUS symbols in the second part of the LP-WUS
The number of OFDM symbols based on SCS for signal/channel of main radio which are used by the LP-WUS
The number of OFDM symbols based on SCS for LP-WUS.
The number of OFDM symbols based on SCS for signal/channel of main radio which are used by the second part of the LP-WUS
The number of OFDM symbols based on SCS for LP-WUS which are used by the second part of the LP-WUS.

In another option, the second part of LP-WUS may be further divided into two sub-parts. The first sub-part can carry information to indicate the length of the second sub-part. This indication can be absolute time, or in unit of WUS symbol or OFDM symbol of main radio. A CRC may be added purely for the first sub-part. Alternatively, there is no CRC for the first sub-part, though the CRC appended after the second sub-part can be calculated by all information in both the first sub-part and the second sub-part. Alternatively, there is no CRC for the first sub-part, while the CRC appended after the second sub-part can be calculated based on only the information of the second sub-part.

In another option, the length of the LP-WUS or the length of the second part of LP-WUS can be determined by blind detection, e.g., by CRC checking. For a possible length, UE may try CRC checking on the received LP-WUS. If CRC passes, UE can conclude the assumption on the length is correct.

In one embodiment, UE may derive timing information based on LP-WUS. For example, LP-WUS may implicitly or explicitly carry timing information of at least one of OFDM symbol, slot, subframe, half frame or radio frame of main radio. Such information can be carried in the second part of the LP-WUS. Such information can be carried in the first part of the LP-WUS. Such information can be carried in both the first and the second parts of the LP-WUS.

In one option, a LP-WUS may indicate the offset of the LP-WUS from the start of a subframe in main radio. By this way, UE can derive the subframe timing of main radio. FIG. 2 illustrates one example for the offset of LP-WUS relative to the start of a subframe.

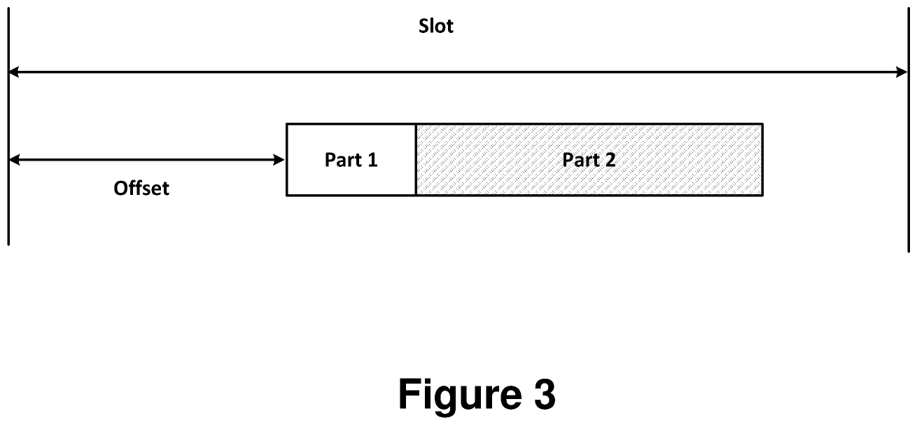

In another option, a LP-WUS may indicate the offset of the LP-WUS from the start of a slot in main radio. By this way, UE can derive the slot timing of main radio. FIG. 3 illustrates one example for the offset of LP-WUS relative to the start of a slot.

In another option, a LP-WUS may indicate the offset of the LP-WUS from the start of a radio frame in main radio. By this way, UE can derive the radio frame timing of main radio.

In another option, a LP-WUS may indicate the offset of the LP-WUS from the start of a half radio frame in main radio. By this way, UE can derive the half radio frame timing of main radio.

In one embodiment, assuming spreading/repetition is applied to the second part of LP-WUS, the multiple spread or repeated WUS symbols for an information bit can be mapped to different time location of the LP-WUS.

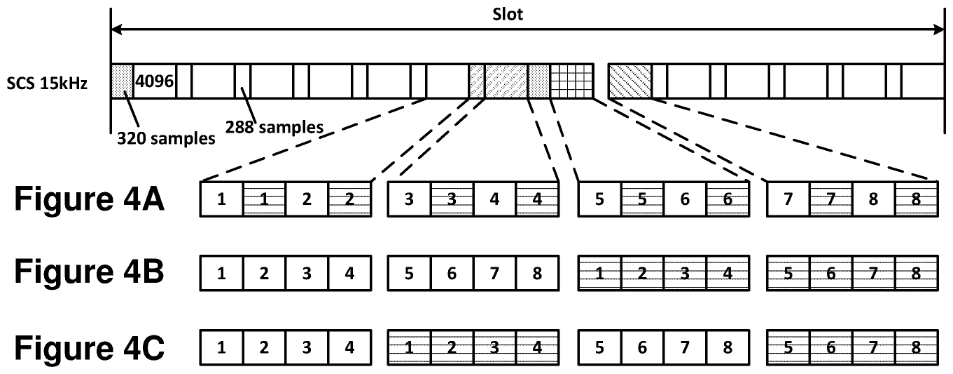

In one option, as shown in FIG. 4A, the multiple spread or repeated WUS symbols for an information bit can be mapped to consecutive WUS symbols. Note: depending on the spreading factor and the number of WUS symbols in an OFDM symbol of main radio, the multiple spread or repeated WUS symbols for an information bit may be mapped to same or different OFDM symbol of main radio.

In another option, as shown in FIG. 4B, the k_th spread or repeated WUS symbol for an information bit can be mapped after the (k−1)_th WUS symbols of all the information bits are mapped.

In another option, as shown in FIG. 4C, the spread or repeated WUS symbols for an information bit can be mapped to the same indexed WUS symbols in consecutive OFDM symbols.

In another option, assuming the LP-WUS is to be transmitted in multiple slots, e.g., multiple consecutive slots, the spread or repeated WUS symbol for an information bit can be mapped the multiple slots.

Common Part 1 for Multiple LP-WUS

In one embodiment, for LP-WUS with two parts, a group of LP-WUS can share a common part 1. Consequently, multiple UEs that use different LP-WUS can share the common part 1. The common part 1 may be same as the part 1 for a LP-WUS transmitted in single subframe or slot. Alternatively, the duration of the common part 1 may be increased to improve the detection performance of part 1. For example, assuming N LP-WUS share a common part 1, the duration of the part 1 may N times longer. The periodicity of the common part 1 could be same as or different from the periodicity of the associated part 2.

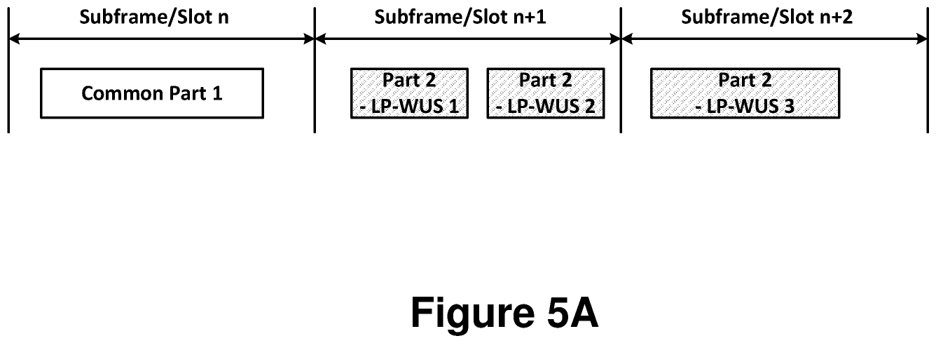

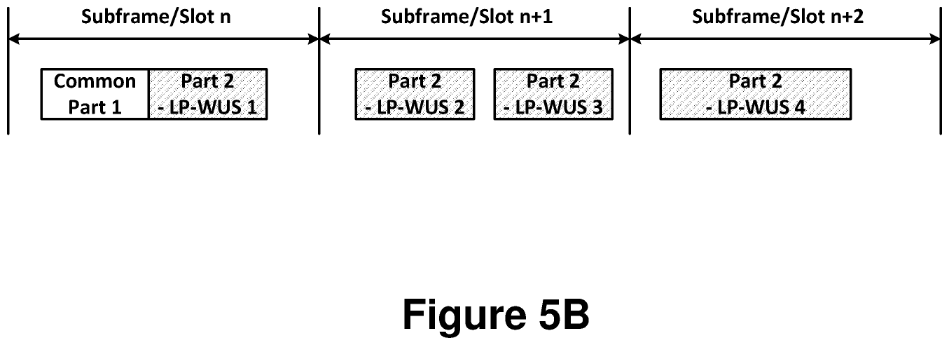

In one option, the common part 1 is configured in a subframe or slot while the associated part 2 of a group of LP-WUS can be configured in different subframes or slots. The subframes or slots for common part 1 and the associated part 2 of the group of LP-WUS can be in adjacent subframes or slots. Alternatively, the gap of subframes or slots can be configured by high layer signaling. FIG. 5A illustrates one example that the common part 1 is a first subframe or slot, while the associated part 2 of the group of LP-WUS are in the following two subframes or slots.

In another option, one or more associated part 2 can be configured in the same subframe or slot as the common part 1 of a group of LP-WUS, while other associated part 2 can be in different subframes or slots. FIG. 5B illustrates one example that the common part 1 is a first subframe or slot, while the associated multiple part 2 are all three subframes or slots.

In one embodiment, for a group of LP-WUS sharing the common part 1, each LP-WUS can be separately configured. Consequently, multiple UEs that use different LP-WUS can share the common part 1. The offset within a period for the part 1 and part 2 of a LP-WUS can be configured separately. It is up to gNB configuration to align the part 1 of the multiple LP-WUS in the group. The common part 1 may be transmitted in a subframe or slot. Alternatively, the common part 1 can be repeatedly transmitted in multiple subframes or slots in the period. Each associated part 2 may be transmitted in a subframe or slot. Alternatively, each associated part 2 can be repeatedly transmitted in multiple subframes or slots in the period.

In one embodiment, the common part 1 for a group of LP-WUS can be separately configured from the associated part 2 of the group of LP-WUS. Consequently, multiple UEs that use different LP-WUS can share the common part 1. To configure the common part 1, the related parameters can include periodicity, offset in a periodicity, number of repetitions. To configure the associated part 2, the offset of each associated part 2 can be separately configured. Alternatively, the offset of the first associated part 2 is configured and the following associated part 2 occupies consecutive OFDM symbols with or without a gap. The gap can be fixed or configured by high layer signaling.

LP-WUS in Multiple Slots

A LP-WUS can be transmitted in multiple subframes or slots. The same time resource for the LP-WUS transmission may be allocated in the multiple subframes or slots. Since the duration for LP-WUS transmission is increased, better link performance can be achieved. Note: the time resource for a LP-WUs in the multiple subframes or slots can be consecutive if all OFDM symbols in a subframe or slot are allocated to the LP-WUS. Otherwise, the time resource for a LP-WUs in the multiple subframes or slots can be non-consecutive.

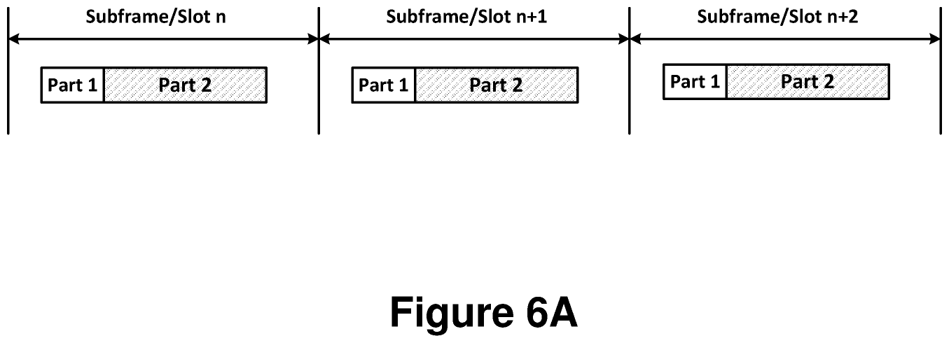

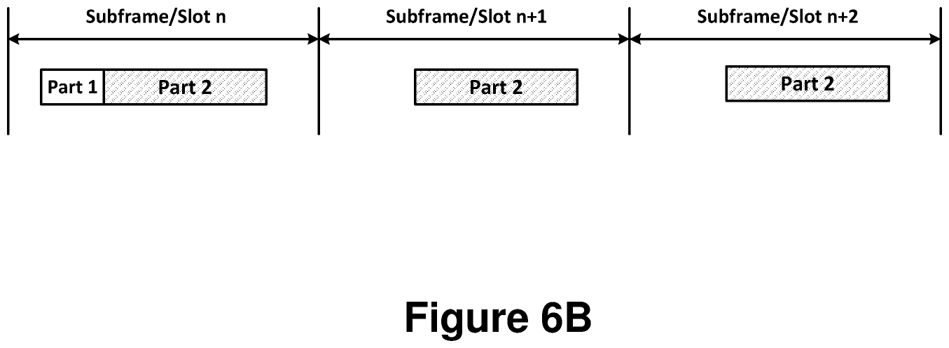

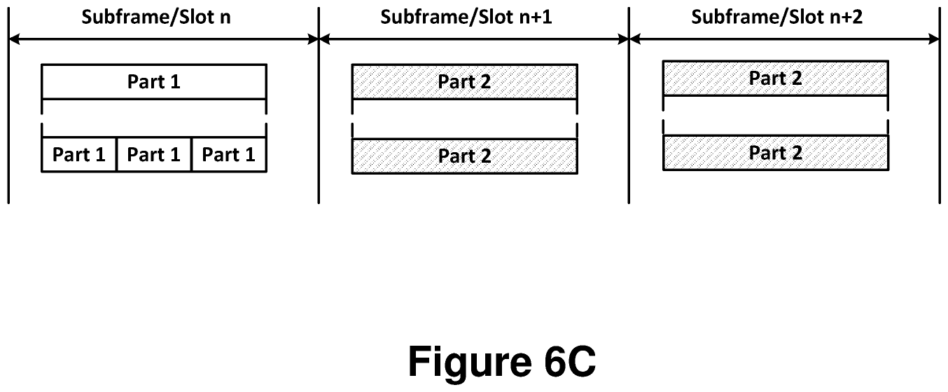

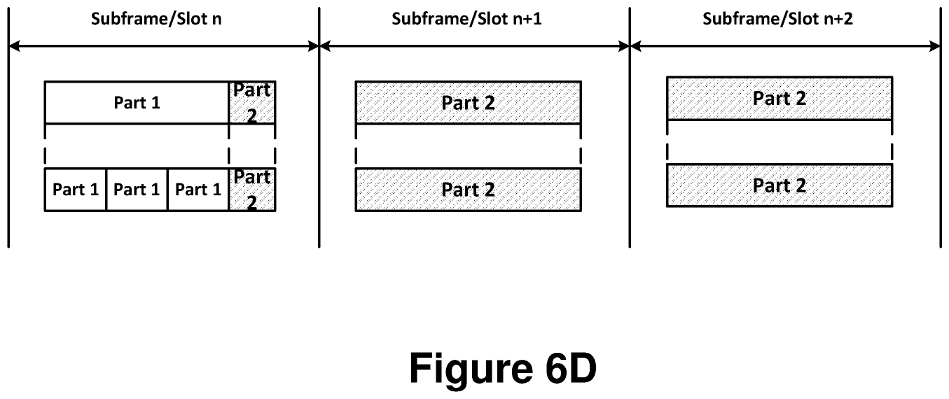

In one embodiment, the part 1 and part 2 of the LP-WUS are both transmitted in the multiple subframes or slots. FIG. 6A illustrates one example to transmit both part 1 and part 2 in 3 consecutive subframes or slots.

In a first option, the part 1 or part 2 of the LP-WUS for the transmission in one subframe or slot are first determined. Then, the determined part 1 or part 2 are repeatedly transmitted in the multiple subframes or slots. For example, a sequence for the transmission of the part 1 in one subframe or slot is determined, then the sequence is repeatedly transmitted in the multiple subframes or slots. For example, the payload of part 2 is encoded and repeatedly transmitted in the multiple subframes or slots.

In a second option, the part 1 or part 2 of the LP-WUS for the transmission in one subframe or slot are first determined. Then, the different version of the part 1 or part 2 can be transmitted in the multiple subframes or slots. For example, multiple sequences suitable for the transmission of the part 1 in one subframe or slot are determined and respectively transmitted in the multiple subframes or slots. Note: the multiple sequence may be generated by the different cyclic shifts of the same root sequence or generated in accordance with the subframe or slot index. For example, the payload of part 2 is encoded and the different coded bits can be transmitted in the multiple subframes or slots.

In a third option, the part 1 or part 2 of the LP-WUS are determined according to the union of time resources in the multiple subframes or slots. For example, a long sequence for the transmission of the part 1 in the time resource in the multiple subframes or slots are determined and transmitted. For example, the payload of part 2 is encoded and transmitted in the time resources across the multiple subframes or slots.

In a fourth option, if the part 1 or part 2 of the LP-WUS carries information of multiple bits, the multiple bits for part 1 or part 2 may divided into multiple segments and each segment is transmitted in a different subframe or slot of the multiple subframes or slots.

The part 1 and part 2 of the LP-WUS may use the same option for the transmission in the multiple subframes or slots. Alternatively, the part 1 and part 2 of the LP-WUS may use the different option for the transmission in the multiple subframes or slots. For example, the part 1 is repeatedly transmitted in the multiple subframes or slots, e.g., the first option, while the part 2 use the second option for transmission.

In one embodiment, the part 1 of the LP-WUS is only transmitted in the first subframe or slot, while the part 2 of the LP-WUS can be transmitted in the multiple subframes or slots. The time resource used by the part 2 in the later subframes or slots can be same as that of the first subframe or slot. FIG. 6B illustrates one example to only transmit part 2 in 3 consecutive subframes or slots.

In this embodiment, the multiple options disclosed in the previous embodiment may be applied to the transmission of the part 2 of the LP-WUS.

In one embodiment, when X subframes or slots are allocated for a LP-WUS, the part 1 of the LP-WUS can be mapped to the first X1 subframes or slots, while the part 2 of the LP-WUS can be mapped to the remaining X-X1 subframes or slots, where X1<X. For example, X1=1. FIG. 6C illustrates one example to transmit part 1 in X1=1 subframe or slot, and transmit part 2 in the last X2=2 consecutive subframes or slots.

In this embodiment, the multiple options disclosed in the previous embodiment may be applied to the part 1 in the first X1 subframes or slots, and applied to the part 2 in the last X2 subframes or slots. Specifically, the part 1 can be determined according to all the allocated time resource in the first X1 subframes or slots. Alternatively, the part 1 can be determined according to all the allocated time resource in a subframe or slot. Alternatively, the part 1 can be determined assuming both part 1 and part 2 are to be multiplexed in the allocated time resource in single subframe or slot. In this case, the part 1 may need to be repeated multiple times in a subframe or slot. FIG. 5C shows an example that the determined part 1 is repeated for 3 times and transmitted in the first subframe or slot.

In one embodiment, when X subframes or slots are allocated for a LP-WUS, the part 1 of the LP-WUS can be mapped to the first X1 subframes or slots, and the remaining resource in the X subframes or slots that are not occupied by the part 1 can be used for the part 2 of the LP-WUS, where X1<X. For example, X1=1. The part 1 may not occupy all allocated time resource the X1_th subframe or slot.

FIG. 6D illustrates an example for the transmission of part 2 on the remaining resource after mapping the part 1. The time resource for the part 1 is increased compared to LP-WUS transmission in single subframe or slot, however, the part 1 doesn't use up all time source for the LP-WUS in the first subframe or slot. The remaining time resource in the first subframe or slot, and the time resource in the next two subframes or slots can be used for the part 2 of the LP-WUS.

In this embodiment, the multiple options disclosed int the previous embodiment may be applied to the part 1 in the time resource for the part 1 in the first X1 subframes or slots and applied to the part 2 in the remaining time resources. Specifically, the part 1 can be determined according to all the time resource for the part 1 in the first X1 subframes or slots. Alternatively, the part 1 can be determined according to all the allocated time resource in a subframe or slot. Alternatively, the part 1 can be determined assuming both part 1 and part 2 are to be multiplexed in the allocated time resource in single subframe or slot. In this case, the part 1 may need to be repeated transmitted multiple times in a subframe or slot. FIG. 6D shows an example that the determined part 1 is repeated for 3 times and transmitted in the allocated time resource in the first subframe or slot.

LP-WUS in Consecutively Repeated Time Resources

To increase the time duration for a LP-WUS, another scheme to transmit the LP-WUS in consecutively repeated time resources is disclosed. In the following description, it is named as time resource unit (TRU) for a time resource without repetition. Compared with embodiments for LP-WUS transmissions in multiple subframes or slots, the only difference is that the allocated time resources in the multiple TRUs are consecutive in time.

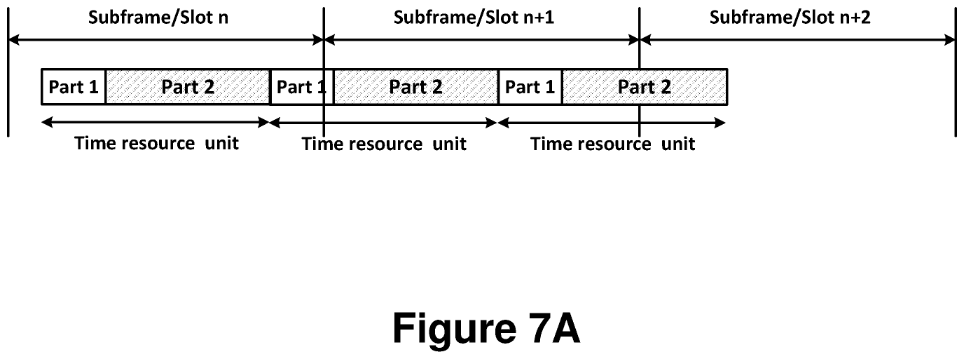

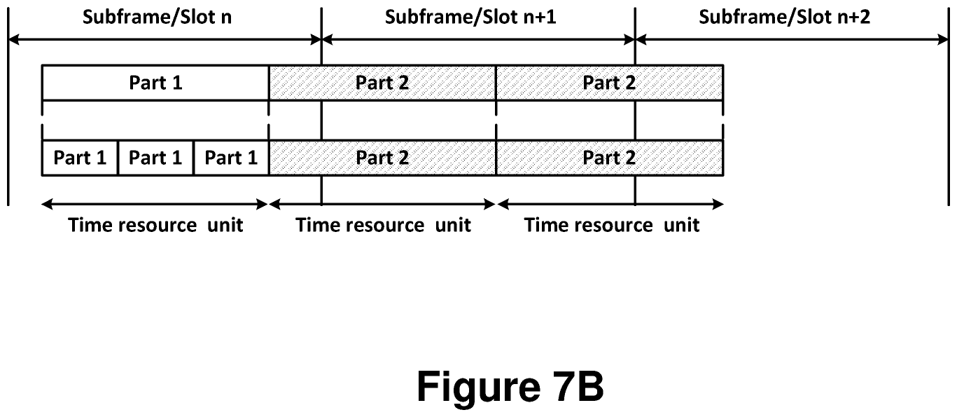

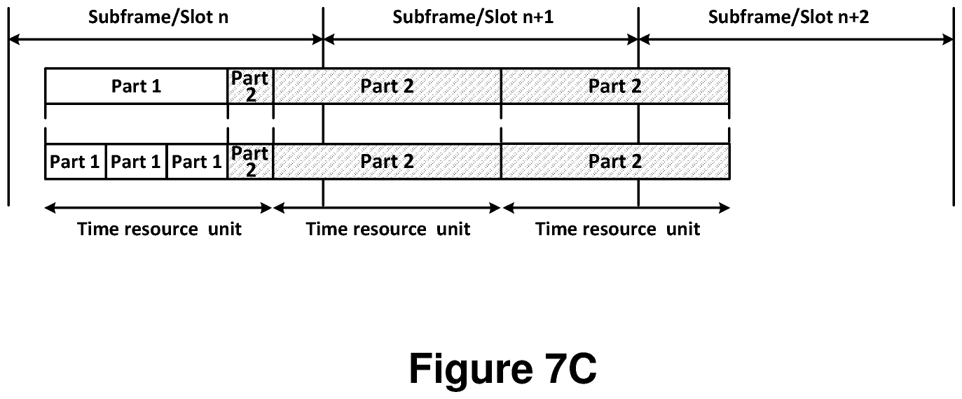

In one embodiment, the part 1 and part 2 of the LP-WUS are both transmitted in the multiple TRUs. FIG. 7A illustrates one example to transmit both part 1 and part 2 in 3 consecutive TRUs.

In a first option, the part 1 or part 2 of the LP-WUS for the transmission in one TRU are first determined. Then, the determined part 1 or part 2 are repeatedly transmitted in the multiple TRUs. For example, a sequence for the transmission of the part 1 in one TRU is determined, then the sequence is repeatedly transmitted in the multiple TRUs. For example, the payload of part 2 is encoded and a same redundancy version of the coded bits are transmitted in the multiple TRUs.

In a second option, the part 1 or part 2 of the LP-WUS for the transmission in one TRU are first determined. Then, the different version of the part 1 or part 2 can be transmitted in the multiple TRUs. For example, multiple sequences suitable for the transmission of the part 1 in one TRU are determined and respectively transmitted in the multiple TRUs. Note: the multiple sequence may be generated by the different cyclic shifts of the same root sequence or generated in accordance with the TRU index. For example, the payload of part 2 is encoded and the different coded bits are transmitted in the multiple TRUs.

In a third option, the part 1 or part 2 of the LP-WUS are determined according to the union of time resources in the multiple TRUs. For example, a long sequence for the transmission of the part 1 in all the time resources across the multiple TRUs are determined and transmitted. For example, the payload of part 2 is encoded and transmitted in all the time resources across the multiple TRUs.

In a fourth option, if the part 1 or part 2 of the LP-WUS carries information of multiple bits, the multiple bits for part 1 or part 2 may divided into multiple segments and each segment is transmitted in a different TRU of the multiple subframes or slots.

The part 1 and part 2 of the LP-WUS may use the same option for the transmission in the multiple TRUs. Alternatively, the part 1 and part 2 of the LP-WUS may use the different option for the transmission in the multiple TRUs. For example, the part 1 is repeatedly transmitted in the multiple TRUs, e.g., the first option, while the part 2 use the second option for transmission.

In one embodiment, when X TRUs are allocated for a LP-WUS, the part 1 of the LP-WUS can be mapped to the first X1 TRUs, while the part 2 of the LP-WUS can be mapped to the remaining X-X1 TRUs, where X1<X. For example, X1=1. FIG. 7B illustrates one example to transmit part 1 in X1=1 TRU, and transmit part 2 in the last X2=2 consecutive TRUs.

In this embodiment, the multiple options disclosed in the previous embodiment may be applied to the part 1 in the first X1 TRUs and applied to the part 2 in the last X2 TRUs. Specifically, the part 1 can be determined according to all the allocated time resources in the first X1 TRUs. Alternatively, the part 1 can be determined according to all the allocated time resources in a TRU. Alternatively, the part 1 can be determined assuming both part 1 and part 2 are to be multiplexed in single TRU. In this case, the part 1 may need to be repeated multiple times in a TRU. FIG. 7B shows an example that the determined part 1 is repeated for 3 times and transmitted in the first TRU.

In one embodiment, when X TRUs are allocated for a LP-WUS, the part 1 of the LP-WUS can be mapped to the first X1 TRUs, and the remaining resource in the X TRUs that are not occupied by the part 1 can be used for the part 2 of the LP-WUS, where X1<X. For example, X1=1. The part 1 may not occupy all allocated time resource the X1_th TRU.

FIG. 7C illustrate an example for the transmission of part 2 on the remaining resource after mapping the part 1. The time resource for the part 1 is increased compared to LP-WUS transmission in single TRU, however, the part 1 doesn't use up all time source for the LP-WUS in the first TRU. The remaining time resource in the first TRU, and the time resource in the next two TRUs can be used for the part 2 of the LP-WUS.

In this embodiment, the multiple options disclosed int the previous embodiment may be applied to the part 1 in the time resource for the part 1 in the first X1 TRUs and applied to the part 2 in the remaining time resources. Specifically, the part 1 can be determined according to all the time resource for the part 1 in the first X1 TRUs. Alternatively, the part 1 can be determined according to all the allocated time resource in a TRU. Alternatively, the part 1 can be determined assuming both part 1 and part 2 are to be multiplexed in single TRU. In this case, the part 1 may need to be repeated transmitted multiple times in a TRU. FIG. 5D shows an example that the determined part 1 is repeated for 3 times and transmitted in the allocated time resources in the first TRU.

### Systems and Implementations

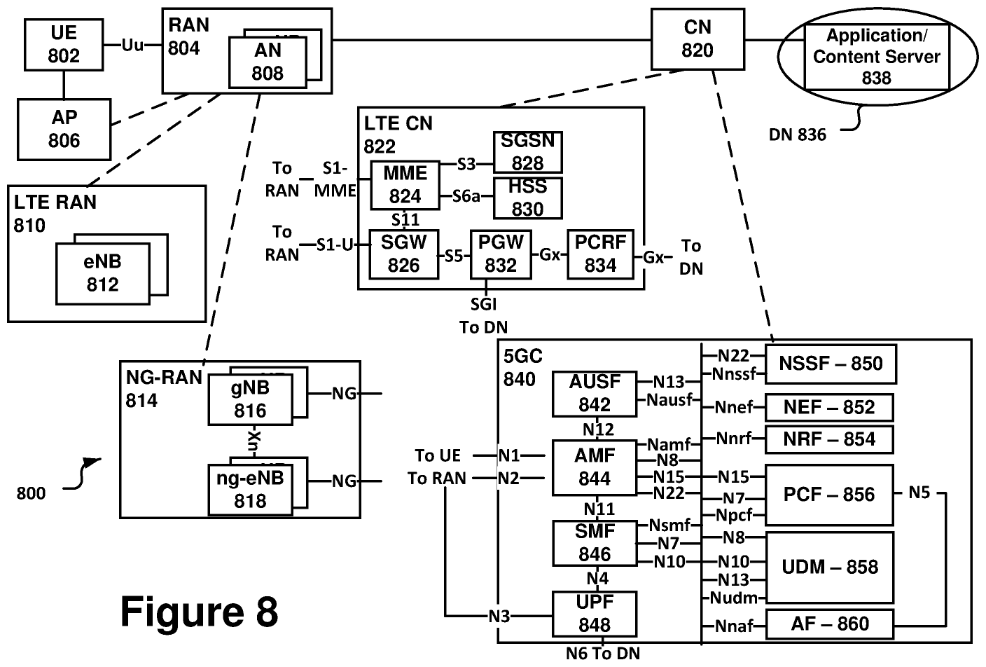

FIGS. 8-10 illustrate various systems, devices, and components that may implement aspects of disclosed embodiments.

FIG. 8 illustrates a network 800 in accordance with various embodiments. The network 800 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 800 may include a UE 802, which may include any mobile or non-mobile computing device designed to communicate with a RAN 804 via an over-the-air connection. The UE 802 may be communicatively coupled with the RAN 804 by a Uu interface. The UE 802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 802 may additionally communicate with an AP 806 via an over-the-air connection. The AP 806 may manage a WLAN connection, which may serve to offload some/all network traffic from the RAN 804. The connection between the UE 802 and the AP 806 may be consistent with any IEEE 802.11 protocol, wherein the AP 806 could be a wireless fidelity (Wi-Fi®) router. In some embodiments, the UE 802, RAN 804, and AP 806 may utilize cellular-WLAN aggregation (for example, LWA/LWIP). Cellular-WLAN aggregation may involve the UE 802 being configured by the RAN 804 to utilize both cellular radio resources and WLAN resources.

The RAN 804 may include one or more access nodes, for example, AN 808. AN 808 may terminate air-interface protocols for the UE 802 by providing access stratum protocols including RRC, PDCP, RLC, MAC, and L1 protocols. In this manner, the AN 808 may enable data/voice connectivity between CN 820 and the UE 802. In some embodiments, the AN 808 may be implemented in a discrete device or as one or more software entities running on server computers as part of, for example, a virtual network, which may be referred to as a CRAN or virtual baseband unit pool. The AN 808 be referred to as a BS, gNB, RAN node, eNB, ng-eNB, NodeB, RSU, TRxP, TRP, etc. The AN 808 may be a macrocell base station or a low power base station for providing femtocells, picocells or other like cells having smaller coverage areas, smaller user capacity, or higher bandwidth compared to macrocells.

In embodiments in which the RAN 804 includes a plurality of ANs, they may be coupled with one another via an X2 interface (if the RAN 804 is an LTE RAN) or an Xn interface (if the RAN 804 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 804 may each manage one or more cells, cell groups, component carriers, etc. to provide the UE 802 with an air interface for network access. The UE 802 may be simultaneously connected with a plurality of cells provided by the same or different ANs of the RAN 804. For example, the UE 802 and RAN 804 may use carrier aggregation to allow the UE 802 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 802 or AN 808 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 804 may be an LTE RAN 810 with eNB s, for example, eNB 812. The LTE RAN 810 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 804 may be an NG-RAN 814 with gNB s, for example, gNB 816, or ng-eNBs, for example, ng-eNB 818. The gNB 816 may connect with 5G-enabled UEs using a 5G NR interface. The gNB 816 may connect with a 5G core through an NG interface, which may include an N2 interface or an N3 interface. The ng-eNB 818 may also connect with the 5G core through an NG interface, but may connect with a UE via an LTE air interface. The gNB 816 and the ng-eNB 818 may connect with each other over an Xn interface.

In some embodiments, the NG interface may be split into two parts, an NG user plane (NG-U) interface, which carries traffic data between the nodes of the NG-RAN 814 and a UPF 848 (e.g., N3 interface), and an NG control plane (NG-C) interface, which is a signaling interface between the nodes of the NG-RAN814 and an AMF 844 (e.g., N2 interface).

The NG-RAN 814 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 802 can be configured with multiple BWPs where each BWP configuration has a different SCS. When a BWP change is indicated to the UE 802, the SCS of the transmission is changed as well. Another use case example of BWP is related to power saving. In particular, multiple BWPs can be configured for the UE 802 with different amount of frequency resources (for example, PRBs) to support data transmission under different traffic loading scenarios. A BWP containing a smaller number of PRBs can be used for data transmission with small traffic load while allowing power saving at the UE 802 and in some cases at the gNB 816. A BWP containing a larger number of PRBs can be used for scenarios with higher traffic load.

The RAN 804 is communicatively coupled to CN 820 that includes network elements to provide various functions to support data and telecommunications services to customers/subscribers (for example, users of UE 802). The components of the CN 820 may be implemented in one physical node or separate physical nodes. In some embodiments, NFV may be utilized to virtualize any or all of the functions provided by the network elements of the CN 820 onto physical compute/storage resources in servers, switches, etc. A logical instantiation of the CN 820 may be referred to as a network slice, and a logical instantiation of a portion of the CN 820 may be referred to as a network sub-slice.

In some embodiments, the CN 820 may be an LTE CN 822, which may also be referred to as an EPC. The LTE CN 822 may include MME 824, SGW 826, SGSN 828, HSS 830, PGW 832, and PCRF 834 coupled with one another over interfaces (or “reference points”) as shown. Functions of the elements of the LTE CN 822 may be briefly introduced as follows.

The MME 824 may implement mobility management functions to track a current location of the UE 802 to facilitate paging, bearer activation/deactivation, handovers, gateway selection, authentication, etc.

The SGW 826 may terminate an S1 interface toward the RAN and route data packets between the RAN and the LTE CN 822. The SGW 826 may be a local mobility anchor point for inter-RAN node handovers and also may provide an anchor for inter-3GPP mobility. Other responsibilities may include lawful intercept, charging, and some policy enforcement.

The SGSN 828 may track a location of the UE 802 and perform security functions and access control. In addition, the SGSN 828 may perform inter-EPC node signaling for mobility between different RAT networks; PDN and S-GW selection as specified by MME 824; MME selection for handovers; etc. The S3 reference point between the MME 824 and the SGSN 828 may enable user and bearer information exchange for inter-3GPP access network mobility in idle/active states.

The HSS 830 may include a database for network users, including subscription-related information to support the network entities' handling of communication sessions. The HSS 830 can provide support for routing/roaming, authentication, authorization, naming/addressing resolution, location dependencies, etc. An S6a reference point between the HSS 830 and the MME 824 may enable transfer of subscription and authentication data for authenticating/authorizing user access to the LTE CN 820.

The PGW 832 may terminate an SGi interface toward a data network (DN) 836 that may include an application/content server 838. The PGW 832 may route data packets between the LTE CN 822 and the data network 836. The PGW 832 may be coupled with the SGW 826 by an S5 reference point to facilitate user plane tunneling and tunnel management. The PGW 832 may further include a node for policy enforcement and charging data collection (for example, PCEF). Additionally, the SGi reference point between the PGW 832 and the data network 8 36 may be an operator external public, a private PDN, or an intra-operator packet data network, for example, for provision of IMS services. The PGW 832 may be coupled with a PCRF 834 via a Gx reference point.

The PCRF 834 is the policy and charging control element of the LTE CN 822. The PCRF 834 may be communicatively coupled to the app/content server 838 to determine appropriate QoS and charging parameters for service flows. The PCRF 832 may provision associated rules into a PCEF (via Gx reference point) with appropriate TFT and QCI.

In some embodiments, the CN 820 may be a 5GC 840. The 5GC 840 may include an AUSF 842, AMF 844, SMF 846, UPF 848, NSSF 850, NEF 852, NRF 854, PCF 856, UDM 858, and AF 860 coupled with one another over interfaces (or “reference points”) as shown. Functions of the elements of the 5GC 840 may be briefly introduced as follows.

The AUSF 842 may store data for authentication of UE 802 and handle authentication-related functionality. The AUSF 842 may facilitate a common authentication framework for various access types. In addition to communicating with other elements of the 5GC 840 over reference points as shown, the AUSF 842 may exhibit an Nausf service-based interface.

The AMF 844 may allow other functions of the 5GC 840 to communicate with the UE 802 and the RAN 804 and to subscribe to notifications about mobility events with respect to the UE 802. The AMF 844 may be responsible for registration management (for example, for registering UE 802), connection management, reachability management, mobility management, lawful interception of AMF-related events, and access authentication and authorization. The AMF 844 may provide transport for SM messages between the UE 802 and the SMF 846, and act as a transparent proxy for routing SM messages. AMF 844 may also provide transport for SMS messages between UE 802 and an SMSF. AMF 844 may interact with the AUSF 842 and the UE 802 to perform various security anchor and context management functions. Furthermore, AMF 844 may be a termination point of a RAN CP interface, which may include or be an N2 reference point between the RAN 804 and the AMF 844; and the AMF 844 may be a termination point of NAS (N1) signaling, and perform NAS ciphering and integrity protection. AMF 844 may also support NAS signaling with the UE 802 over an N3 IWF interface.

The SMF 846 may be responsible for SM (for example, session establishment, tunnel management between UPF 848 and AN 808); UE IP address allocation and management (including optional authorization); selection and control of UP function; configuring traffic steering at UPF 848 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 844 over N2 to AN 808; and determining SSC mode of a session. SM may refer to management of a PDU session, and a PDU session or “session” may refer to a PDU connectivity service that provides or enables the exchange of PDUs between the UE 802 and the data network 836.

The UPF 848 may act as an anchor point for intra-RAT and inter-RAT mobility, an external PDU session point of interconnect to data network 836, and a branching point to support multi-homed PDU session. The UPF 848 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 848 may include an uplink classifier to support routing traffic flows to a data network.

The NSSF 850 may select a set of network slice instances serving the UE 802. The NSSF 850 may also determine allowed NSSAI and the mapping to the subscribed S-NSSAIs, if needed. The NSSF 850 may also determine the AMF set to be used to serve the UE 802, or a list of candidate AMFs based on a suitable configuration and possibly by querying the NRF 854. The selection of a set of network slice instances for the UE 802 may be triggered by the AMF 844 with which the UE 802 is registered by interacting with the NSSF 850, which may lead to a change of AMF. The NSSF 850 may interact with the AMF 844 via an N22 reference point; and may communicate with another NSSF in a visited network via an N31 reference point (not shown). Additionally, the NSSF 850 may exhibit an Nnssf service-based interface.

The NEF 852 may securely expose services and capabilities provided by 3GPP network functions for third party, internal exposure/re-exposure, AFs (e.g., AF 860), edge computing or fog computing systems, etc. In such embodiments, the NEF 852 may authenticate, authorize, or throttle the AFs. NEF 852 may also translate information exchanged with the AF 860 and information exchanged with internal network functions. For example, the NEF 852 may translate between an AF-Service-Identifier and an internal 5GC information. NEF 852 may also receive information from other NFs based on exposed capabilities of other NFs. This information may be stored at the NEF 852 as structured data, or at a data storage NF using standardized interfaces. The stored information can then be re-exposed by the NEF 852 to other NFs and AFs, or used for other purposes such as analytics. Additionally, the NEF 852 may exhibit an Nnef service-based interface.

The NRF 854 may support service discovery functions, receive NF discovery requests from NF instances, and provide the information of the discovered NF instances to the NF instances. NRF 854 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 854 may exhibit the Nnrf service-based interface.

The PCF 856 may provide policy rules to control plane functions to enforce them, and may also support unified policy framework to govern network behavior. The PCF 856 may also implement a front end to access subscription information relevant for policy decisions in a UDR of the UDM 858. In addition to communicating with functions over reference points as shown, the PCF 856 exhibit an Npcf service-based interface.

The UDM 858 may handle subscription-related information to support the network entities' handling of communication sessions, and may store subscription data of UE 802. For example, subscription data may be communicated via an N8 reference point between the UDM 858 and the AMF 844. The UDM 858 may include two parts, an application front end and a UDR. The UDR may store subscription data and policy data for the UDM 858 and the PCF 856, and/or structured data for exposure and application data (including PFDs for application detection, application request information for multiple UEs 802) for the NEF 852. The Nudr service-based interface may be exhibited by the UDR 221 to allow the UDM 858, PCF 856, and NEF 852 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 858 may exhibit the Nudm service-based interface.

The AF 860 may provide application influence on traffic routing, provide access to NEF, and interact with the policy framework for policy control.

In some embodiments, the 5GC 840 may enable edge computing by selecting operator/3rd party services to be geographically close to a point that the UE 802 is attached to the network. This may reduce latency and load on the network. To provide edge-computing implementations, the 5GC 840 may select a UPF 848 close to the UE 802 and execute traffic steering from the UPF 848 to data network 836 via the N6 interface. This may be based on the UE subscription data, UE location, and information provided by the AF 860. In this way, the AF 860 may influence UPF (re)selection and traffic routing. Based on operator deployment, when AF 860 is considered to be a trusted entity, the network operator may permit AF 860 to interact directly with relevant NFs. Additionally, the AF 860 may exhibit an Naf service-based interface.

The data network 836 may represent various network operator services, Internet access, or third party services that may be provided by one or more servers including, for example, application/content server 838.

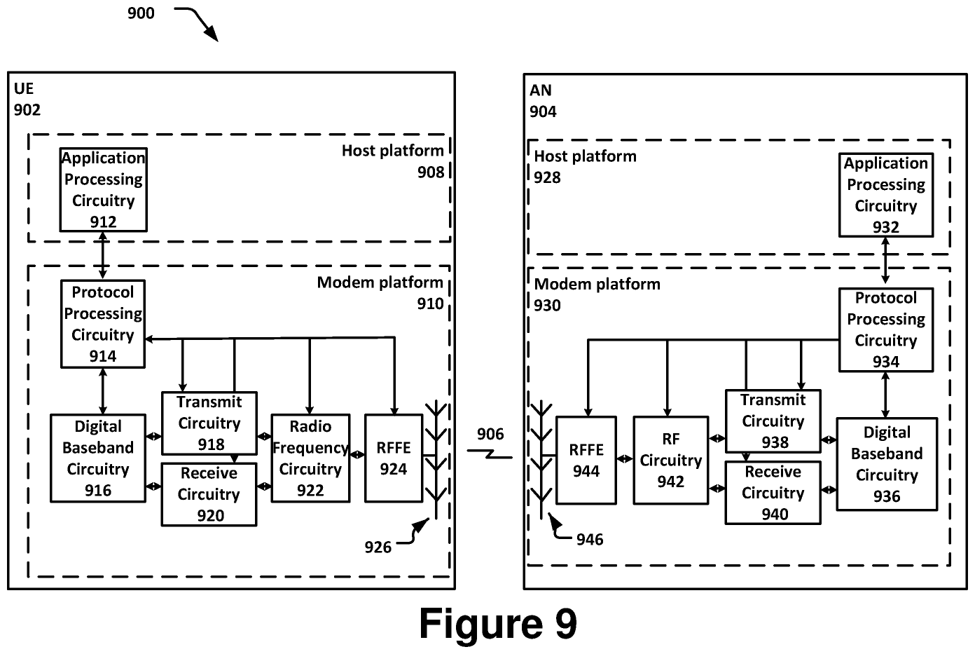

FIG. 9 schematically illustrates a wireless network 900 in accordance with various embodiments. The wireless network 900 may include a UE 902 in wireless communication with an AN 904. The UE 902 and AN 904 may be similar to, and substantially interchangeable with, like-named components described elsewhere herein.

The UE 902 may be communicatively coupled with the AN 904 via connection 906. The connection 906 is illustrated as an air interface to enable communicative coupling, and can be consistent with cellular communications protocols such as an LTE protocol or a 5G NR protocol operating at mmWave or sub-6 GHz frequencies.

The UE 902 may include a host platform 908 coupled with a modem platform 910. The host platform 908 may include application processing circuitry 912, which may be coupled with protocol processing circuitry 914 of the modem platform 910. The application processing circuitry 912 may run various applications for the UE 902 that source/sink application data. The application processing circuitry 912 may further implement one or more layer operations to transmit/receive application data to/from a data network. These layer operations may include transport (for example UDP) and Internet (for example, IP) operations

The protocol processing circuitry 914 may implement one or more of layer operations to facilitate transmission or reception of data over the connection 906. The layer operations implemented by the protocol processing circuitry 914 may include, for example, MAC, RLC, PDCP, RRC and NAS operations.

The modem platform 910 may further include digital baseband circuitry 916 that may implement one or more layer operations that are “below” layer operations performed by the protocol processing circuitry 914 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 910 may further include transmit circuitry 918, receive circuitry 920, RF circuitry 922, and RF front end (RFFE) 924, which may include or connect to one or more antenna panels 926. Briefly, the transmit circuitry 918 may include a digital-to-analog converter, mixer, intermediate frequency (IF) components, etc.; the receive circuitry 920 may include an analog-to-digital converter, mixer, IF components, etc.; the RF circuitry 922 may include a low-noise amplifier, a power amplifier, power tracking components, etc.; RFFE 924 may include filters (for example, surface/bulk acoustic wave filters), switches, antenna tuners, beamforming components (for example, phase-array antenna components), etc. The selection and arrangement of the components of the transmit circuitry 918, receive circuitry 920, RF circuitry 922, RFFE 924, and antenna panels 926 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 914 may include one or more instances of control circuitry (not shown) to provide control functions for the transmit/receive components.

A UE reception may be established by and via the antenna panels 926, RFFE 924, RF circuitry 922, receive circuitry 920, digital baseband circuitry 916, and protocol processing circuitry 914. In some embodiments, the antenna panels 926 may receive a transmission from the AN 904 by receive-beamforming signals received by a plurality of antennas/antenna elements of the one or more antenna panels 926.

A UE transmission may be established by and via the protocol processing circuitry 914, digital baseband circuitry 916, transmit circuitry 918, RF circuitry 922, RFFE 924, and antenna panels 926. In some embodiments, the transmit components of the UE 904 may apply a spatial filter to the data to be transmitted to form a transmit beam emitted by the antenna elements of the antenna panels 926.

Similar to the UE 902, the AN 904 may include a host platform 928 coupled with a modem platform 930. The host platform 928 may include application processing circuitry 932 coupled with protocol processing circuitry 934 of the modem platform 930. The modem platform may further include digital baseband circuitry 936, transmit circuitry 938, receive circuitry 940, RF circuitry 942, RFFE circuitry 944, and antenna panels 946. The components of the AN 904 may be similar to and substantially interchangeable with like-named components of the UE 902. In addition to performing data transmission/reception as described above, the components of the AN 908 may perform various logical functions that include, for example, RNC functions such as radio bearer management, uplink and downlink dynamic radio resource management, and data packet scheduling.

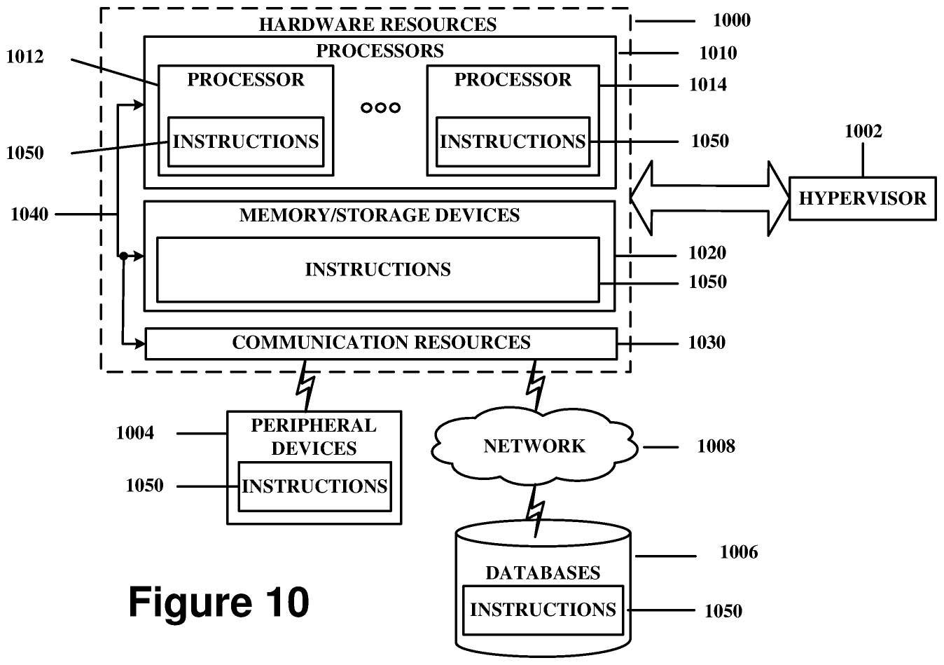

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040 or other interface circuitry. For embodiments where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014. The processors 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1020 may include main memory, disk storage, or any suitable combination thereof. The memory/storage devices 1020 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface controllers, components, or other suitable devices to communicate with one or more peripheral devices 1004 or one or more databases 1006 or other network elements via a network 1008. For example, the communication resources 1030 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

Example Procedures

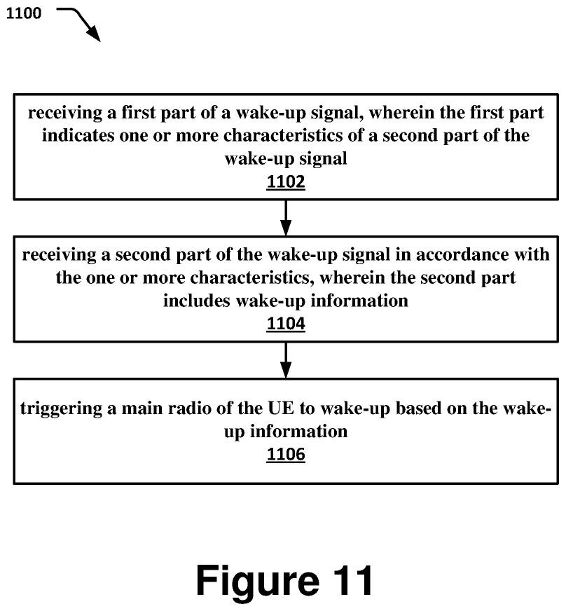

In some embodiments, the electronic device(s), network(s), system(s), chip(s) or component(s), or portions or implementations thereof, of FIGS. 8-10, or some other figure herein, may be configured to perform one or more processes, techniques, or methods as described herein, or portions thereof. One such process 1100 is depicted in FIG. 11. The process 1100 may be performed by a UE or a portion thereof. For example, the UE may have a wake-up receiver and a main receiver as discussed herein. At 1102, the process 1100 may include receiving a first part of a wake-up signal, wherein the first part indicates one or more characteristics of a second part of the wake-up signal. At 1104, the process 1100 may further include receive a second part of the wake-up signal in accordance with the one or more characteristics, wherein the second part includes wake-up information. At 1106, the process 1100 may further include triggering a main radio of the UE to wake-up based on the wake-up information.

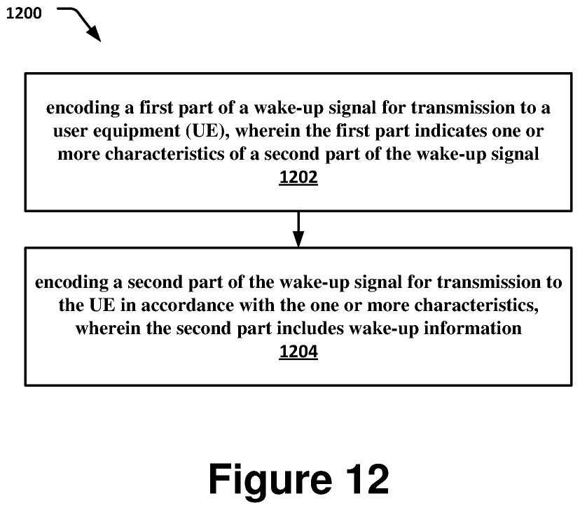

FIG. 12 illustrates another example process 1200 in accordance with various embodiments. In some embodiments, the process 1200 may be performed by a gNB or a portion thereof. At 1202, the process 1200 may include encoding a first part of a wake-up signal for transmission to a user equipment (UE), wherein the first part indicates one or more characteristics of a second part of the wake-up signal. At 1204, the process 1200 may further include encoding a second part of the wake-up signal for transmission to the UE in accordance with the one or more characteristics, wherein the second part includes wake-up information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Some non-limiting examples of various embodiments are provided below.

Example A1 may include an apparatus to be implemented in a user equipment (UE), the apparatus comprising: a main receiver; and a wake-up receiver. The wake-up receiver is to: receive a wake-up signal with a first part and a second part, wherein the second part includes wake-up information and is received based on the first part; and trigger the main receiver to wake up based on the wake-up signal.

Example A2 may include the apparatus of example A1, wherein the wake-up receiver is to perform automatic gain control or time-frequency synchronization based on the first part to receive the second part.

Example A3 may include the apparatus of example A1, wherein the wake-up receiver is to determine a starting symbol, symbol duration, a coding rate, a spreading factor, or a length of the second part based on the first part.

Example A4 may include the apparatus of example A3, wherein the symbol duration, the coding rate, or the spreading factor of the second part is determined based on a sequence of the first part.

Example A5 may include the apparatus of example A1, wherein the first part is received based on an on-off keying (OOF) modulation scheme or a frequency shift keying (FSK) modulation scheme.

Example A6 may include the apparatus of example A1, wherein the first and second parts are consecutive in time, or there is a time gap between the first part and the second part.

Example A7 may include the apparatus of example A1, wherein the first part and the second part are both repeated or received in one or more subframes, slots, or time resource units.

Example A8 may include the apparatus of example A1, wherein the first part is received in only one subframe, slot, or time resource unit, and wherein the second part is repeated or received in one or more subframes, slots, or time resource units.

Example A9 may include the apparatus of example A1, wherein the first part is mapped to a first subset of subframes, slots, or time resource units of an allocation, and wherein the second part is mapped to remaining subframes, slots, or time resource units of the allocation.

Example A10 may include the apparatus of any one of examples A1-A9, wherein the first part is shared by a group of UEs.

Example A11 may include one or more non-transitory computer-readable media (NTCRM) having instructions, stored thereon, that when executed by one or more processors configure a next generation Node B (gNB) to: encode a first part of a wake-up signal for transmission to a user equipment (UE), wherein the first part indicates one or more characteristics of a second part of the wake-up signal; and encode a second part of the wake-up signal for transmission to the UE in accordance with the one or more characteristics, wherein the second part includes wake-up information.

Example A12 may include the one or more NTCRM of example A11, wherein the one or more characteristics include a starting symbol, symbol duration, a coding rate, a spreading factor, or a length of the second part.

Example A13 may include the one or more NTCRM of example A11, wherein the one or more characteristics are indicated by a sequence of the first part.

Example A14 may include the one or more NTCRM of example A11, wherein the first part is encoded based on an on-off keying (OOF) modulation scheme or a frequency shift keying (FSK) modulation scheme.

Example A15 may include the one or more NTCRM of example A11, wherein the first and second parts are consecutive in time, or there is a time gap between the first part and the second part.

Example A16 may include the one or more NTCRM of example A11, wherein the first part and the second part are both repeated or transmitted in one or more subframes, slots, or time resource units.

Example A17 may include the one or more NTCRM of example A11, wherein the first part is transmitted in only one subframe or slot, and wherein the second part is repeated or transmitted in one or more subframes, slots, or time resource units.

Example A18 may include the one or more NTCRM of example A11, wherein the first part is mapped to a first subset of subframes, slots, or time resource units of an allocation, and wherein the second part is mapped to remaining subframes, slots, or time resource units of the allocation.

Example A19 may include the one or more non-transitory computer-readable media (NTCRM) having instructions, stored thereon, that when executed by one or more processors configure a user equipment (UE) to: receive a first part of a wake-up signal, wherein the first part indicates one or more characteristics of a second part of the wake-up signal; receive a second part of the wake-up signal in accordance with the one or more characteristics, wherein the second part includes wake-up information; and trigger a main radio of the UE to wake-up based on the wake-up information.

Example A20 may include the one or more NTCRM of example A19, wherein the one or more characteristics include a starting symbol, symbol duration, a coding rate, a spreading factor, or a length of the second part.

Example A21 may include the one or more NTCRM of example A19, wherein the first and second parts are consecutive in time, or there is a time gap between the first part and the second part.

Example A22 may include the one or more NTCRM of example A19, wherein the first part and the second part are both repeated or received in one or more subframes, slots, or time resource units.

Example A23 may include the one or more NTCRM of example A19, wherein the first part is repeated or received in only one subframe or slot, and wherein the second part is received in one or more subframes, slots, or time resource units.

Example A24 may include the one or more NTCRM of example A19, wherein the first part is mapped to a first subset of subframes, slots, or time resource units of an allocation, and wherein the second part is mapped to remaining subframes, slots, or time resource units of the allocation.

Example B1 may include a method for low power wake-up signal design in time domain.

Example B2 may include the method of example B1 or some other example herein, wherein a wake-up signal/channel consists of at least two parts.

Example B3 may include the method of example B3 or some other example herein, both parts consist of multiple WUS symbols.

Example B4 may include the method of example B3 or some other example herein, wherein the two parts are consecutive in time, or there is a time gap between the first part and the second part.

Example B5 may include the method of example B3 or some other example herein, wherein multiple sequence lengths are supported for the first part of a LP-WUS.

Example B6 may include the method of example B3 or some other example herein, wherein multiple durations of a WUS symbol are supported for the first part of a LP-WUS.

Example B7 may include the method of example B3 or some other example herein, wherein multiple durations of a WUS symbol are supported for the second part of a LP-WUS.

Example B8 may include the method of examples B5 or B7 or some other example herein, wherein the duration of a WUS symbol of the second part is same as or different from the duration of a WUS symbol of the first part.

Example B9 may include the method of example B3 or some other example herein, multiple coding rate or spreading factors are supported for the second part of a LP-WUS.

Example B10 may include the method of example B3 or some other example herein, wherein multiple lengths of LP-WUS are supported.

Example B11 may include the method of example B10 or some other example herein, the length of LP-WUS is indicated by the first part or by the beginning sub-part of the second part.

Example B12 may include the method of example B3 or some other example herein, wherein LP-WUS implicitly or explicitly carries timing information of at least one of OFDM symbol, slot, subframe, half frame or radio frame of main radio.

Example B13 may include the method of example B3 or some other example herein, wherein assuming spreading or repetition is applied to the second part of LP-WUS, the multiple spread or repeated WUS symbols for an information bit are mapped to different time location of the LP-WUS.

Example B14 may include the method of example B3 or some other example herein, wherein a group of LP-WUS can share a common part 1.

Example B15 may include the method of example B3 or some other example herein, wherein the part 1 and part 2 of the LP-WUS are both transmitted in the multiple subframes or slots.

Example B16 may include the system and method of example B3 or some other example herein, wherein the part 1 of the LP-WUS is only transmitted in the first subframe or slot, while the part 2 of the LP-WUS can be transmitted in the multiple subframes or slots.

Example B17 may include the method of example B3 or some other example herein, wherein the part 1 of the LP-WUS can be mapped to the first X1 subframes or slots, while the part 2 of the LP-WUS can be mapped to the remaining X-X1 subframes or slots, where X1<X.

Example B18 may include the method of example B3 or some other example herein, wherein the part 1 of the LP-WUS can be mapped to the first X1 subframes or slots, and the remaining resource in the X subframes or slots that are not occupied by the part 1 can be used for the part 2 of the LP-WUS, where X1<X.

Example B19 may include the method of example B3 or some other example herein, the LP-WUS is transmitted in consecutively repeated time resources Example B20 may include a method of a UE, the method comprising:
receiving configuration information for a wake-up signal (WUS) with a first part and a second part;
receiving the first part based on the configuration information; and
receiving the second part based on the first part.

Example B21 may include the method of example B20 or some other example herein, wherein the first and second parts include multiple WUS symbols.

Example B22 may include the method of example B20-21 or some other example herein, wherein the first and second parts are consecutive in time, or there is a time gap between the first part and the second part.

Example B23 may include the method of example B20-22 or some other example herein, wherein multiple sequence lengths are supported for the first part.

Example B24 may include the method of example B20-23 or some other example herein, wherein multiple durations of a WUS symbol are supported for the first part.

Example B25 may include the method of example B20-24 or some other example herein, wherein multiple durations of a WUS symbol are supported for the second part.

Example B26 may include the method of example B20-25 or some other example herein, wherein the duration of a WUS symbol of the second part is the same as or different from the duration of a WUS symbol of the first part.

Example B27 may include the method of example B20-26 or some other example herein, wherein the first part is shared by a group of WUSs.

Example B28 may include the method of example B20-27 or some other example herein, wherein the first part and the second part are both received in multiple subframes or slots.

Example B29 may include the method of example B20-27 or some other example herein, wherein the first part is received in only one subframe or slot, and wherein the second part is received in multiple subframes or slots.

Example B30 may include the method of example B20-29 or some other example herein, wherein the first part is mapped to a first X1 subframes or slots of an allocation, and wherein the second part is mapped to the remaining X-X1 subframes or slots of the allocation, where X1<X.

Example B31 may include the method of example B20-29 or some other example herein, wherein the WUS is received in consecutively repeated time resources.

Example Z01 may include an apparatus comprising means to perform one or more elements of a method described in or related to any of examples A1-A24, B1-B31, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A24, B1-B31, or any other method or process described herein.

Example Z03 may include an apparatus comprising logic, modules, or circuitry to perform one or more elements of a method described in or related to any of examples A1-A24, B1-B31, or any other method or process described herein.

Example Z04 may include a method, technique, or process as described in or related to any of examples A1-A24, B1-B31, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A24, B1-B31, or portions thereof.

Example Z06 may include a signal as described in or related to any of examples A1-A24, B1-B31, or portions or parts thereof.

Example Z07 may include a datagram, packet, frame, segment, protocol data unit (PDU), or message as described in or related to any of examples A1-A24, B1-B31, or portions or parts thereof, or otherwise described in the present disclosure.

Example Z08 may include a signal encoded with data as described in or related to any of examples A1-A24, B1-B31, or portions or parts thereof, or otherwise described in the present disclosure.

Example Z09 may include a signal encoded with a datagram, packet, frame, segment, protocol data unit (PDU), or message as described in or related to any of examples A1-A24, B1-B31, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A24, B1-B31, or portions thereof.

Example Z11 may include a computer program comprising instructions, wherein execution of the program by a processing element is to cause the processing element to carry out the method, techniques, or process as described in or related to any of examples A1-A24, B1-B31, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation |
| | Partnership Project |
| 4G | Fourth Generation |
| 5G | Fifth Generation |
| 5GC | 5G Core network |
| AC | Application |
| | Client |
| ACR | Application Context |
| | Relocation |
| ACK | Acknowledgement |
| ACID | Application |
| | Client Identification |
| AF | Application Function |
| AM | Acknowledged Mode |
| AMBR | Aggregate Maximum |
| | Bit Rate |
| AMF | Access and Mobility |
| | Management |
| | Function |
| AN | Access Network |
| ANR | Automatic |
| | Neighbour Relation |
| AOA | Angle of |
| | Arrival |
| AP | Application Protocol, |
| | Antenna Port, Access |
| | Point |
| API | Application |
| | Programming Interface |
| APN | Access Point Name |
| ARP | Allocation and |
| | Retention Priority |
| ARQ | Automatic Repeat |
| | Request |
| AS | Access Stratum |
| ASP | Application |
| | Service Provider |
| ASN.1 | Abstract Syntax |
| | Notation One |
| AUSF | Authentication |
| | Server Function |
| AWGN | Additive |
| | White Gaussian Noise |
| BAP | Backhaul Adaptation |
| | Protocol |
| BCH | Broadcast Channel |
| BER | Bit Error Ratio |
| BFD | Beam Failure |
| | Detection |
| BLER | Block Error Rate |
| BPSK | Binary Phase Shift |
| | Keying |
| BRAS | Broadband Remote |
| | Access Server |
| BSS | Business Support |
| | System |
| BS | Base Station |
| BSR | Buffer Status Report |
| BW | Bandwidth |
| BWP | Bandwidth Part |
| C-RNTI | Cell Radio |
| | Network Temporary |
| | Identity |
| CA | Carrier Aggregation, |
| | Certification |
| | Authority |
| CAPEX | CAPital |
| | Expenditure |
| CBD | Candidate Beam |
| | Detection |
| CBRA | Contention Based |
| | Random Access |
| CC | Component Carrier, |
| | Country Code, |
| | Cryptographic |
| | Checksum |
| CCA | Clear Channel |
| | Assessment |
| CCE | Control Channel |
| | Element |
| CCCH | Common Control |
| | Channel |
| CE | Coverage |
| | Enhancement |
| CDM | Content Delivery |
| | Network |
| CDMA | Code- |
| | Division Multiple |
| | Access |
| CDR | Charging Data |
| | Request |
| CDR | Charging Data |
| | Response |
| CFRA | Contention Free |
| | Random Access |
| CG | Cell Group |
| CGF | Charging |
| | Gateway Function |
| CHF | Charging |
| | Function |
| CI | Cell Identity |
| CID | Cell-ID (e.g., |
| | positioning method) |
| CIM | Common |
| | Information Model |
| CIR | Carrier to |
| | Interference Ratio |
| CK | Cipher Key |
| CM | Connection |
| | Management, Conditional |
| | Mandatory |
| CMAS | Commercial Mobile |
| | Alert Service |
| CMD | Command |
| CMS | Cloud Management |
| | System |
| CO | Conditional Optional |
| COMP | Coordinated Multi- |
| | Point |
| CORESET | Control |
| | Resource Set |
| COTS | Commercial Off- |
| | The-Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot |
| | Channel |
| CQI | Channel Quality |
| | Indicator |
| CPU CSI | processing unit, |
| | Central Processing |
| | Unit |
| C/R | Command/Response |
| field | bit |
| CRAN | Cloud Radio Access |
| | Network, Cloud |
| | RAN |
| CRB | Common Resource |
| | Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSCF | call session |
| | control function |
| CSAR | Cloud Service |
| | Archive |
| CSI | Channel-State |
| | Information |
| CSI-IM | CSI |
| | Interference Measurement |
| CSI-RS | CSI |
| | Reference Signal |
| CSI-RSRP | CSI reference |
| | signal received power |
| CSI-RSRQ | CSI reference |
| | signal received quality |
| CSI-SINR | CSI signal-to- |
| | noise and interference |
| | ratio |
| CSMA | Carrier Sense |
| | Multiple Access |
| CSMA/CA | CSMA with |
| | collision avoidance |
| CSS | Common Search |
| | Space, Cell- specific |
| | Search Space |
| CTF | Charging |
| | Trigger Function |
| CTS | Clear-to-Send |
| CW | Codeword |
| CWS | Contention Window |
| | Size |
| D2D | Device-to-Device |
| DC | Dual Connectivity, |
| | Direct Current |
| DCI | Downlink Control |
| | Information |
| DF | Deployment Flavour |
| DL | Downlink |
| DMTF | Distributed |
| | Management Task Force |
| DPDK | Data Plane |
| | Development Kit |
| DM-RS, DMRS | Demodulation |
| | Reference Signal |
| DN | Data network |
| DNN | Data Network |
| | Name |
| DNAI | Data Network |
| | Access Identifier |
| DRB | Data Radio Bearer |
| DRS | Discovery Reference |
| | Signal |
| DRX | Discontinuous |
| | Reception |
| DSL | Domain Specific |
| | Language, Digital |
| | Subscriber Line |
| DSLAM | DSL Access |
| | Multiplexer |
| DwPTS | Downlink |
| | Pilot Time Slot |
| E-LAN | Ethernet |
| | Local Area Network |
| E2E | End-to-End |
| EAS | Edge Application |
| | Server |
| ECCA | extended clear |
| | channel assessment, |
| | extended CCA |
| ECCE | Enhanced Control |
| | Channel Element, |
| | Enhanced CCE |
| ED | Energy Detection |
| EDGE | Enhanced Datarates |
| | for GSM Evolution |
| | (GSM Evolution) |
| EAS | Edge |
| | Application Server |
| EASID | Edge |
| | Application Server |
| | Identification |
| ECS | Edge |
| | Configuration Server |
| ECSP | Edge |
| | Computing Service |
| | Provider |
| EDN | Edge Data |
| | Network |
| EEC | Edge Enabler |
| | Client |
| EECID | Edge Enabler |
| | Client Identification |
| EES | Edge Enabler |
| | Server |
| EESID | Edge Enabler |
| | Server Identification |
| EHE | Edge Hosting |
| | Environment |
| EGMF | Exposure |
| | Governance Management |
| | Function |
| EGPRS | Enhanced |
| | GPRS |
| EIR | Equipment Identity |
| | Register |
| eLAA | enhanced Licensed |
| | Assisted Access, |
| | enhanced LAA |
| EM | Element Manager |
| eMBB | Enhanced Mobile |
| | Broadband |
| EMS | Element |
| | Management System |
| eNB | evolved NodeB, E- |
| | UTRAN Node B |
| EN-DC | E-UTRA-NR |
| | Dual Connectivity |
| EPC | Evolved Packet Core |
| EPDCCH | enhanced |
| | PDCCH, enhanced |
| | Physical Downlink |
| | Control Cannel |
| EPRE | Energy per resource |
| | element |
| EPS | Evolved Packet |
| | System |
| EREG | enhanced REG, |
| | enhanced resource |
| | element groups |
| ETSI | European |
| | Telecommunications |
| | Standards Institute |
| ETWS | Earthquake and |
| | Tsunami Warning |
| | System |
| eUICC | embedded UICC, |
| | embedded Universal |
| | Integrated Circuit Card |
| E-UTRA | Evolved |
| | UTRA |
| E-UTRAN | Evolved |
| | UTRAN |
| EV2X | Enhanced V2X |
| F1AP | F1 Application |
| | Protocol |
| F1-C | F1 Control plane |
| | interface |
| F1-U | F1 User plane |
| | interface |
| FACCH | Fast |
| | Associated Control |
| | CHannel |
| FACCH/F | Fast |
| | Associated Control |
| | Channel/Full rate |
| FACCH/H | Fast |
| | Associated Control |
| | Channel/Half rate |
| FACH | Forward Access |
| | Channel |
| FAUSCH | Fast Uplink |
| | Signalling Channel |
| FB | Functional Block |
| FBI | Feedback |
| | Information |
| FCC | Federal |
| | Communications |
| | Commission |
| FCCH | Frequency |
| | Correction CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error |
| | Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field-Programmable |
| | Gate Array |
| FR | Frequency Range |
| FQDN | Fully Qualified |
| | Domain Name |
| G-RNTI | GERAN |
| | Radio Network |
| | Temporary Identity |
| GERAN | GSM EDGE |
| | RAN, GSM EDGE Radio |
| | Access Network |
| GGSN | Gateway GPRS |
| | Support Node |
| GLONASS | GLObal'naya |
| | NAvigatsionnaya |
| | Sputnikovaya |
| | Sistema (Engl .: |
| | Global Navigation |
| | Satellite System) |
| gNB | Next Generation |
| | NodeB |
| gNB-CU | gNB- |
| | centralized unit, Next |
| | Generation NodeB |
| | centralized unit |
| gNB-DU | gNB- |
| | distributed unit, Next |
| | Generation NodeB |
| | distributed unit |
| GNSS | Global Navigation |
| | Satellite System |
| GPRS | General Packet |
| | Radio Service |
| GPSI | Generic Public |
| | Subscription Identifier |
| GSM | Global System for |
| | Mobile |
| | Communications, |
| | Groupe Spécial |
| | Mobile |
| GTP GPRS | Tunneling |
| | Protocol |
| GTP-UGPRS | Tunnelling |
| | Protocol for User |
| | Plane |
| GTS | Go To Sleep Signal |
| | (related to WUS) |
| GUMMEI | Globally |
| | Unique MME Identifier |
| GUTI | Globally Unique |
| | Temporary UE Identity |
| HARQ | Hybrid ARQ, Hybrid |
| | Automatic Repeat |
| | Request |
| HANDO | Handover |
| HFN | HyperFrame Number |
| HHO | Hard Handover |
| HLR | Home Location |
| | Register |
| HN | Home Network |
| HO | Handover |
| HPLMN | Home Public |
| | Land Mobile Network |
| HSDPA | High Speed |
| | Downlink Packet |
| | Access |
| HSN | Hopping Sequence |
| | Number |
| HSPA | High Speed Packet |
| | Access |
| HSS | Home Subscriber |
| | Server |
| HSUPA | High Speed |
| | Uplink Packet Access |
| HTTP | Hyper Text Transfer |
| | Protocol |
| HTTPS | Hyper Text |
| | Transfer Protocol |
| | Secure (https is |
| | http/1.1 over SSL, |
| | i.e. port 443) |
| I-Block | Information |
| | Block |
| ICCID | Integrated Circuit |
| | Card Identification |
| IAB | Integrated Access |
| | and Backhaul |
| ICIC | Inter-Cell |
| | Interference Coordination |
| ID | Identity, identifier |
| IDFT | Inverse Discrete |
| | Fourier Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data |
| | Length |
| IETF | Internet Engineering |
| | Task Force |
| IF | Infrastructure |
| IIOT | Industrial Internet of |
| | Things |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia |
| | Private Identity |
| IMPU | IP Multimedia |
| | PUblic identity |
| IMS | IP Multimedia |
| | Subsystem |
| IMSI | International Mobile |
| | Subscriber Identity |
| IOT | Internet of Things |
| IP | Internet Protocol |
| Ipsec | IP Security, Internet |
| | Protocol Security |
| IP-CAN | IP- |
| | Connectivity Access |
| | Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking- |
| | Function |
| I-WLAN | Interworking |
| | WLAN |
| | Constraint length of |
| | the convolutional code, |
| | USIM Individual key |
| kB | Kilobyte (1000 |
| | bytes) |
| kbps | kilo-bits per second |
| Kc | Ciphering key |
| Ki | Individual subscriber |
| | authentication key |
| KPI | Key Performance |
| | Indicator |
| KQI | Key Quality |
| | Indicator |
| KSI | Key Set Identifier |
| ksps | kilo-symbols per |
| | second |
| KVM | Kernel Virtual |
| | Machine |
| L1 | Layer 1 (physical |
| | layer) |
| L1-RSRP | Layer 1 |
| | reference signal |
| | received power |
| L2 | Layer 2 (data link |
| | layer) |
| L3 | Layer 3 (network |
| | layer) |
| LAA | Licensed Assisted |
| | Access |
| LAN | Local Area Network |
| LADN | Local Area |
| | Data Network |
| LBT | Listen Before Talk |
| LCM | LifeCycle |
| | Management |
| LCR | Low Chip Rate |
| LCS | Location Services |
| LCID | Logical |
| | Channel ID |
| LI | Layer Indicator |
| LLC | Logical Link |
| | Control, Low Layer |
| | Compatibility |
| LMF | Location |
| | Management Function |
| LOS | Line of Sight |
| LPLMN | Local PLMN |
| LPP | LTE Positioning |
| | Protocol |
| LSB | Least Significant Bit |
| LTE | Long Term |
| | Evolution |
| LWA | LTE-WLAN |
| | aggregation |
| LWIP | LTE/WLAN Radio |
| | Level Integration with |
| | IPsec Tunnel |
| LTE | Long Term |
| | Evolution |
| M2M | Machine-to-Machine |
| MAC | Medium Access |
| | Control (protocol |
| | layering context) |
| MAC | Message |
| | authentication code |
| | (security/encryption |
| | context) |
| MAC-A | MAC used |
| | for authentication and |
| | key agreement (TSG T |
| | WG3 context) |
| MAC-IMAC | used for data |
| | integrity of signalling |
| | messages (TSG T |
| | WG3 context) |
| MANO | Management |
| | and Orchestration |
| MBMS | Multimedia |
| | Broadcast and Multicast |
| | Service |
| MBSFN | Multimedia |
| | Broadcast multicast |
| | service Single Frequency |
| | Network |
| MCC | Mobile Country |
| | Code |
| MCG | Master Cell Group |
| MCOT | Maximum Channel |
| | Occupancy Time |
| MCS | Modulation and |
| | coding scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility |
| | Management |
| MME | Mobility |
| | Management Entity |
| MN | Master Node |
| MNO | Mobile |
| | Network Operator |
| MO | Measurement Object, |
| | Mobile Originated |
| MPBCH | MTC |
| | Physical Broadcast |
| | CHannel |
| MPDCCH | MTC |
| | Physical Downlink |
| | Control CHannel |
| MPDSCH | MTC |
| | Physical Downlink |
| | Shared CHannel |
| MPRACH | MTC |
| | Physical Random |
| | Access CHannel |
| MPUSCH | MTC |
| | Physical Uplink Shared |
| | Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling |
| | Information |
| MSID | Mobile Station |
| | Identifier |
| MSIN | Mobile Station |
| | Identification |
| | Number |
| MSISDN | Mobile |
| | Subscriber ISDN |
| | Number |
| MT | Mobile Terminated, |
| | Mobile Termination |
| MTC | Machine-Type |
| | Communications |
| mMTC | massive MTC, |
| | massive Machine- |
| | Type Communications |
| MU-MIMO | Multi User |
| | MIMO |
| MWUS | MTC wake- |
| | up signal, MTC WUS |
| NACK | Negative |
| | Acknowledgement |
| NAI | Network Access |
| | Identifier |
| NAS | Non-Access Stratum, |
| | Non- Access Stratum layer |
| NCT | Network |
| | Connectivity Topology |
| NC-JT | Non- |
| | Coherent Joint |
| | Transmission |
| NEC | Network Capability |
| | Exposure |
| NE-DC | NR-E-UTRA |
| | Dual Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, |
| | Next Gen |
| NGEN-DC | NG-RAN E- |
| | UTRA-NR Dual |
| | Connectivity |
| NM | Network Manager |
| NMS | Network |
| | Management System |
| N-POP | Network Point of |
| | Presence |
| NMIB, N-MIB | Narrowband |
| | MIB |
| NPBCH | Narrowband |
| | Physical Broadcast |
| | CHannel |
| NPDCCH | Narrowband |
| | Physical Downlink |
| | Control CHannel |
| NPDSCH | Narrowband |
| | Physical Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband Primary |
| | Synchronization |
| | Signal |
| NSSS | Narrowband |
| | Secondary |
| | Synchronization |
| | Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single- |
| | NSSAI |
| NSSF | Network Slice |
| | Selection Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit - type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average |
| | Power Ratio |
| PAR | Peak to Average |
| | Ratio |
| PBCH | Physical Broadcast |
| | Channel |
| PC | Power Control, |
| | Personal Computer |
| PCC | Primary Component |
| | Carrier, Primary CC |
| P-CSCF | Proxy CSCF |
| PCell | Primary Cell |
| PCI | Physical Cell ID, |
| | Physical Cell Identity |
| PCEF | Policy and Charging |
| | Enforcement |
| | Function |
| PCF | Policy Control |
| | Function |
| PCRF | Policy Control and |
| | Charging Rules |
| | Function |
| PDCP | Packet Data |
| | Convergence Protocol, |
| | Packet Data Convergence |
| | Protocol layer |
| PDCCH | Physical |
| | Downlink Control |
| | Channel |
| PDCP | Packet Data |
| | Convergence Protocol |
| PDN | Packet Data |
| | Network, Public Data |
| | Network |
| PDSCH | Physical |
| | Downlink Shared |
| | Channel |
| PDU | Protocol Data Unit |
| PEI | Permanent |
| | Equipment Identifiers |
| PFD | Packet Flow |
| | Description |
| P-GW | PDN Gateway |
| PHICH | Physical |
| | hybrid-ARQ indicator |
| | channel |
| PHY | Physical layer |
| PLMN | Public Land Mobile |
| | Network |
| PIN | Personal |
| | Identification Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point |
| | Protocol |
| PRACH | Physical |
| | RACH |
| PRB | Physical resource |
| | block |
| PRG | Physical resource |
| | block group |
| ProSe | Proximity Services, |
| | Proximity-Based |
| | Service |
| PRS | Positioning |
| | Reference Signal |
| PRR | Packet Reception |
| | Radio |
| PS | Packet Services |
| PSBCH | Physical |
| | Sidelink Broadcast |
| | Channel |
| PSDCH | Physical |
| | Sidelink Downlink |
| | Channel |
| PSCCH | Physical |
| | Sidelink Control |
| | Channel |
| PSSCH | Physical |
| | Sidelink Shared |
| | Channel |
| PSFCH | physical |
| | sidelink feedback |
| | channel |
| PSCell | Primary SCell |
| PSS | Primary |
| | Synchronization Signal |
| PSTN | Public Switched |
| | Telephone Network |
| PT-RS | Phase-tracking |
| | reference signal |
| PTT | Push-to-Talk |
| PUCCH | Physical |
| | Uplink Control |
| | Channel |
| PUSCH | Physical |
| | Uplink Shared |
| | Channel |
| QAM | Quadrature |
| | Amplitude Modulation |
| QCI | QoS class of |
| | identifier |
| QCL | Quasi co-location |
| QFI | QOS Flow ID, QoS |
| | Flow Identifier |
| QOS | Quality of Service |
| QPSK | Quadrature |
| | (Quaternary) Phase Shift |
| | Keying |
| QZSS | Quasi-Zenith |
| | Satellite System |
| RA-RNTI | Random |
| | Access RNTI |
| RAB | Radio Access Bearer, |
| | Random Access |
| | Burst |
| RACH | Random Access |
| | Channel |
| RADIUS | Remote |
| | Authentication Dial In |
| | User Service |
| RAN | Radio Access |
| | Network |
| RAND | RANDom number |
| | (used for |
| | authentication) |
| RAR | Random Access |
| | Response |
| RAT | Radio Access |
| | Technology |
| RAU | Routing Area Update |
| RB | Resource block, |
| | Radio Bearer |
| RBG | Resource block |
| | group |
| REG | Resource Element |
| | Group |
| Rel | Release |
| REQ | REQuest |
| RF | Radio Frequency |
| RI | Rank Indicator |
| RIV | Resource indicator |
| | value |
| RL | Radio Link |
| RLC | Radio Link Control, |
| | Radio Link Control layer |
| RLC AM | RLC |
| | Acknowledged Mode |
| RLC UM | RLC |
| | Unacknowledged Mode |
| RLF | Radio Link Failure |
| RLM | Radio Link |
| | Monitoring |
| RLM-RS | Reference |
| | Signal for RLM |
| RM | Registration |
| | Management |
| RMC | Reference |
| | Measurement Channel |
| RMSI | Remaining MSI, |
| | Remaining Minimum |
| | System Information |
| RN | Relay Node |
| RNC | Radio Network |
| | Controller |
| RNL | Radio Network |
| | Layer |
| RNTI | Radio Network |
| | Temporary Identifier |
| ROHC | RObust Header |
| | Compression |
| RRC | Radio Resource |
| | Control, Radio |
| | Resource Control layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time Protocol |
| RTS | Ready-To-Send |
| RTT | Round Trip Time |
| Rx | Reception, |
| | Receiving, Receiver |
| S1AP | S1 Application |
| | Protocol |
| S1-MME | S1 for the |
| | control plane |
| S1-U | S1 for the user plane |
| S-CSCF | serving CSCF |
| S-GW | Serving Gateway |
| S-RNTI | SRNC Radio |
| | Network Temporary |
| | Identity |
| S-TMSI | SAE |
| | Temporary Mobile |
| | Station Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary |
| | Component Carrier, |
| | Secondary CC |
| SCell | Secondary Cell |
| SCEF | Service |
| | Capability Exposure |
| | Function |
| SC-FDMA | Single Carrier |
| | Frequency Division |
| | Multiple Access |
| SCG | Secondary Cell |
| | Group |
| SCM | Security Context |
| | Management |
| SCS | Subcarrier Spacing |
| SCTP | Stream Control |
| | Transmission |
| | Protocol |
| SDAP | Service Data |
| | Adaptation Protocol, |
| | Service Data Adaptation |
| | Protocol layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDT | Small Data |
| | Transmission |
| SDU | Service Data Unit |
| SEAF | Security Anchor |
| | Function |
| SeNB | secondary eNB |
| SEPP | Security Edge |
| | Protection Proxy |
| SFI | Slot format |
| | indication |
| SFTD | Space-Frequency |
| | Time Diversity, SFN and |
| | frame timing difference |
| SFN | System Frame |
| | Number |
| SgNB | Secondary gNB |
| SGSN | Serving GPRS |
| | Support Node |
| S-GW | Serving Gateway |
| SI | System Information |
| SI-RNTI | System |
| | Information RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message |
| | Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| | SP-CSI-RNTISemi- |
| | Persistent CSI RNTI |
| SPS | Semi-Persistent |
| | Scheduling |
| SQN | Sequence number |
| SR | Scheduling Request |
| SRB | Signalling Radio |
| | Bearer |
| SRS | Sounding Reference |
| | Signal |
| SS | Synchronization |
| | Signal |
| SSB | Synchronization |
| | Signal Block |
| SSID | Service Set |
| | Identifier |
| SS/PBCH | Block |
| SSBRI SS/PBCH | Block |
| | Resource Indicator, |
| | Synchronization Signal |
| | Block Resource |
| | Indicator |
| SSC | Session and Service |
| | Continuity |
| SS-RSRP | Synchronization |
| | Signal based Reference |
| | Signal Received Power |
| SS-RSRQ | Synchronization |
| | Signal based Reference |
| | Signal Received |
| | Quality |
| SS-SINR | Synchronization |
| | Signal based Signal to |
| | Noise and Interference |
| | Ratio |
| SSS | Secondary |
| | Synchronization Signal |
| SSSG | Search Space Set |
| | Group |
| SSSIF | Search Space Set |
| | Indicator |
| SST | Slice/Service Types |
| SU-MIMO | Single User |
| | MIMO |
| SUL | Supplementary |
| | Uplink |
| TA | Timing Advance, |
| | Tracking Area |
| TAC | Tracking Area Code |
| TAG | Timing Advance |
| | Group |
| TAI | Tracking |
| | Area Identity |
| TAU | Tracking Area |
| | Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division |
| | Duplex |
| TDM | Time Division |
| | Multiplexing |
| TDMA | Time Division |
| | Multiple Access |
| TE | Terminal Equipment |
| TEID | Tunnel End Point |
| | Identifier |
| TFT | Traffic Flow |
| | Template |
| TMSI | Temporary Mobile |
| | Subscriber Identity |
| TNL | Transport Network |
| | Layer |
| TPC | Transmit Power |
| | Control |
| TPMI | Transmitted |
| | Precoding Matrix |
| | Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN |
| | Radio Network |
| | Temporary Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra- |
| | Reliable and Low |
| | Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal |
| | Terrestrial Radio |
| | Access Network |
| UwPTS | Uplink Pilot |
| | Time Slot |
| V2I | Vehicle-to- |
| | Infrastruction |
| V2P | Vehicle-to- |
| | Pedestrian |
| V2V | Vehicle-to-Vehicle |
| V2X | Vehicle-to- |
| | everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF |
| | Forwarding Graph |
| VNFFGD | VNF |
| | Forwarding Graph |
| | Descriptor |
| VNFM | VNF Manager |
| VOIP | Voice-over-IP, |
| | Voice-over- Internet |
| | Protocol |
| VPLMN | Visited Public |
| | Land Mobile Network |
| VPN | Virtual Private |
| | Network |
| VRB | Virtual Resource |
| | Block |
| WiMAX | Worldwide |
| | Interoperability for |
| | Microwave Access |
| WLAN | Wireless Local Area |
| | Network |
| WMAN | Wireless |
| | Metropolitan Area |
| | Network |
| WPAN | Wireless Personal |
| | Area Network |
| X2-C | X2-Control plane |
| X2-U | X2-User plane |
| XML | extensible Markup |
| | Language |
| XRES | Expected user |
| | RESponse |
| XOR | exclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1. An apparatus to be implemented in a user equipment (UE), the apparatus comprising:
a main receiver; and
a wake-up receiver to:
receive a wake-up signal with a first part and a second part, wherein the second part includes wake-up information and is received based on the first part; and
trigger the main receiver to wake up based on the wake-up signal.

2. The apparatus of claim 1, wherein the wake-up receiver is to perform automatic gain control or time-frequency synchronization based on the first part to receive the second part.

3. The apparatus of claim 1, wherein the wake-up receiver is to determine a starting symbol, symbol duration, a coding rate, a spreading factor, or a length of the second part based on the first part.

4. The apparatus of claim 3, wherein the symbol duration, the coding rate, or the spreading factor of the second part is determined based on a sequence of the first part.

5. The apparatus of claim 1, wherein the first part is received based on an on-off keying (OOF) modulation scheme or a frequency shift keying (FSK) modulation scheme.

6. The apparatus of claim 1, wherein the first and second parts are consecutive in time, or there is a time gap between the first part and the second part.

7. The apparatus of claim 1, wherein the first part and the second part are both repeated or received in one or more subframes, slots, or time resource units.

8. The apparatus of claim 1, wherein the first part is received in only one subframe, slot, or time resource unit, and wherein the second part is repeated or received in one or more subframes, slots, or time resource units.

9. The apparatus of claim 1, wherein the first part is mapped to a first subset of subframes, slots, or time resource units of an allocation, and wherein the second part is mapped to remaining subframes, slots, or time resource units of the allocation.

10. The apparatus of claim 1, wherein the first part is shared by a group of UEs.

11. One or more non-transitory computer-readable media (NTCRM) having instructions, stored thereon, that when executed by one or more processors configure a next generation Node B (gNB) to:
encode a first part of a wake-up signal for transmission to a user equipment (UE), wherein the first part indicates one or more characteristics of a second part of the wake-up signal; and
encode a second part of the wake-up signal for transmission to the UE in accordance with the one or more characteristics, wherein the second part includes wake-up information.

12. The one or more NTCRM of claim 11, wherein the one or more characteristics include a starting symbol, symbol duration, a coding rate, a spreading factor, or a length of the second part.

13. The one or more NTCRM of claim 11, wherein the one or more characteristics are indicated by a sequence of the first part.

14. The one or more NTCRM of claim 11, wherein the first part is encoded based on an on-off keying (00F) modulation scheme or a frequency shift keying (FSK) modulation scheme.

15. The one or more NTCRM of claim 11, wherein the first and second parts are consecutive in time, or there is a time gap between the first part and the second part.

16. The one or more NTCRM of claim 11, wherein:
the first part and the second part are both repeated or transmitted in one or more subframes, slots, or time resource units; or
the first part is transmitted in only one subframe or slot, and wherein the second part is repeated or transmitted in one or more subframes, slots, or time resource units; or
the first part is mapped to a first subset of subframes, slots, or time resource units of an allocation, and wherein the second part is mapped to remaining subframes, slots, or time resource units of the allocation.

17. One or more non-transitory computer-readable media (NTCRM) having instructions, stored thereon, that when executed by one or more processors configure a user equipment (UE) to:
receive a first part of a wake-up signal, wherein the first part indicates one or more characteristics of a second part of the wake-up signal;
receive a second part of the wake-up signal in accordance with the one or more characteristics, wherein the second part includes wake-up information; and
trigger a main radio of the UE to wake-up based on the wake-up information.

18. The one or more NTCRM of claim 17, wherein the one or more characteristics include a starting symbol, symbol duration, a coding rate, a spreading factor, or a length of the second part.

19. The one or more NTCRM of claim 17, wherein the first and second parts are consecutive in time, or there is a time gap between the first part and the second part.

20. The one or more NTCRM of claim 17, wherein:
the first part and the second part are both repeated or received in one or more subframes, slots, or time resource units; or
the first part is repeated or received in only one subframe or slot, and wherein the second part is received in one or more subframes, slots, or time resource units; or
the first part is mapped to a first subset of subframes, slots, or time resource units of an allocation, and wherein the second part is mapped to remaining subframes, slots, or time resource units of the allocation.
